(19) United States
(12) Patent Application Publication
(10) Pub. No.: US 2007/0130511 A1
(43) Pub. Date: Jun. 7, 2007

(54) Method and apparatus for generating a data-entry form

(75) Inventors: James Roberge, Darien, IL (US); Alessandro Davide Donati, Evanston, IL (US); Shawn Schiffner, Hoffman Estates, IL (US); Richard Samsel, Lindenhurst, IL (US); Catherine Elise Duffy, Chicago, IL (US); Jeffrey Soble, Highland Park, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Cyberpulse, L.L.C., Highland Park, IL (US)

(21) Appl. No.: 11/291,865

(22) Filed: Dec. 1, 2005

(51) Int. Cl. G06F 17/00

(52) U.S. Cl. 715/517; 706/48

(57) ABSTRACT

A hierarchically structured knowledge base containing hierarchically ordered data elements is provided (101). One also provides (102) an interactive user interface, wherein the interactive user interface is operably coupled to the hierarchically structured knowledge base. One then generates (103) a data-entry form that is displayable on the interactive user interface using the hierarchically structured knowledge base, wherein the data-entry form contains a plurality of data-entry columns of data-entry opportunities. In a preferred but optional approach, the data-entry opportunities are not necessarily ordered in a manner conforming to the hierarchical order that characterizes the hierarchically structured knowledge base.

### TECHNICAL FIELD

This invention relates generally to data-entry platforms and interactive user interfaces. In particular, it relates to generating data-entry forms and displaying the generated data-entry forms on an interactive user interface.

### BACKGROUND

Data-entry platforms and interactive user interfaces are well known in the art. In many applications, data-entry platforms are used in conjunction with interactive user interfaces to capture data from a user. A data-entry form is displayed on an interactive user interface such that a user can enter data into the data-entry form. For example, the use of databases and spreadsheets is known in the art for capturing data from a user through a data-entry form displayed on an interactive user interface. It is also known in the art to supply a data-entry form that has a plurality of data-entry opportunities. In such a case the data-entry opportunities are typically arranged in a vertical orientation.

For many purposes, such prior art approaches are satisfactory. Nevertheless, there are contexts when certain problems are experienced, particularly when there are a large number of data-entry opportunities that must be populated and, even more so, when there are a very large number of potential data-entry opportunities of varying importance but where only a small subset of these opportunities are likely to be populated in any given data-entry session. In these contexts, all data-entry opportunities often cannot be usefully displayed on the interactive user interface at the same time. A problem arises because the user may then fail to enter data into data-entry opportunities that are not presently displayed in the interactive user interface and the data-entry form fails to capture a complete set of data.

Data-entry forms that effectively encourage a failure to capture all data are unacceptable in many contexts. One approach to alleviate this problem has been the use of vertical scrolling in the interactive user interface combined with vertically oriented data-entry opportunities on data-entry forms. Using this approach, a user vertically scrolls through the data-entry opportunities, thereby bringing them into view in the interactive user interface, and then enters data into the now-visible data-entry opportunities. Such an approach can be problematic, however, because a user is often unaware of the existence of data-entry opportunities not presently in view via the interactive user interface or may be unaware of an ability to vertically scroll through the data-entry opportunities. As a result the user may again miss data-entry opportunities and certain data will not be captured by the data-entry form.

There are also existing database systems having data entry mechanisms that are based on hierarchically-organized views of the data. These hierarchically-organized views, however, do not necessarily represent the actual database structure. Hierarchical views can be created for a variety of data structures including, for example, data structures based on relational tables, hierarchical data structures, and network data structures to name but a few.

One set of prior art techniques for navigating through hierarchically-organized database views is based on a diagrammatic representation of the hierarchy as a whole. In these techniques, a user typically moves around the hierarchy by selecting nodes on the diagram using a mouse or other pointing device. Since the hierarchy is usually very large, only those nodes that lie near the last node selected are displayed. The user can manually move the viewing window (using scroll bars, for instance) and can reveal or hide levels of the hierarchy diagram by manually opening or closing nodes.

These techniques allow a user to view data elements in the context of the overall structure of the hierarchy and to visualize the semantic relationships between data elements. Unfortunately, this emphasis on overall structure renders these approaches ill-suited to the task of data entry. As the user moves down the hierarchy, he or she sees not only the nodes that represent possible choices for the next selection but also large amounts of information that are irrelevant to the current data being entered. In addition, because much of the hierarchy diagram must, by necessity, be off-screen at any point in time, it is often difficult for the user to ascertain how they have reached a particular point in the hierarchy or how the displayed information fits within the overall structure. As a general result, the user is left with little intuitive feel for how to effect a data-entry activity relevant to their particular activities.

Another prior art approach to support navigating through hierarchically-organized database views restricts navigation to movement up and down along the branches in the hierarchy. The contents of the levels that lie along a current branch are displayed as cascading windows or menu lists. Such a system will typically present the person inputting the data with a limited number of choices of data to be entered from which the operator selects specific phrases descriptive, for example, of a health care provider's observations or instructions. These techniques improve somewhat the ease with which a user can identify the current set of choices by placing possible candidates in a topmost window or rightmost list. These techniques, however, are still unnecessarily wasteful of screen space. Much of the screen will typically be cluttered with unselected choices at each of the levels that lie along the current branch. Equally important, navigation remains difficult because important navigational guides for moving back up the hierarchy—the nodes selected along the current path, for instance—are frequently hidden under a window or pushed off-screen entirely.

### BRIEF DESCRIPTION OF THE DRAWINGS

The above needs are at least partially met through provision of the method and apparatus for generating a data-entry form described in the following detailed description, particularly when studied in conjunction with the drawings, wherein:

FIG. 1 comprises a flow diagram as configured in accordance with various embodiments of the invention;

FIG. 2 comprises a diagram illustrative of a hierarchical organization of data as configured in accordance with various embodiments of the invention;

FIG. 3 comprises a view of an interactive user interface as configured in accordance with various embodiments of the invention;

FIG. 4 comprises a view of an interactive user interface as configured in accordance with various embodiments of the invention;

FIG. 5 comprises a flow diagram as configured in accordance with various embodiments of the invention;

FIG. 6 comprises a view of an interactive user interface as configured in accordance with various embodiments of the invention;

FIG. 7 comprises a view of an interactive user interface as configured in accordance with various embodiments of the invention;

FIG. 8 comprises a view of an interactive user interface as configured in accordance with various embodiments of the invention;

FIG. 9 comprises a view of an interactive user interface as configured in accordance with various embodiments of the invention;

FIG. 10 comprises a view of an interactive user interface as configured in accordance with various embodiments of the invention;

FIG. 11 comprises a view of an interactive user interface as configured in accordance with various embodiments of the invention;

FIG. 12 comprises a view of an interactive user interface as configured in accordance with various embodiments of the invention;

FIG. 13 comprises a view of an interactive user interface as configured in accordance with various embodiments of the invention;

FIG. 14 comprises a view of an interactive user interface as configured in accordance with various embodiments of the invention;

FIG. 15 comprises a view of an interactive user interface as configured in accordance with various embodiments of the invention;

FIG. 16 comprises a view of an interactive user interface as configured in accordance with various embodiments of the invention;

FIG. 17 comprises a view of an interactive user interface as configured in accordance with various embodiments of the invention;

FIG. 18 comprises a view of an interactive user interface as configured in accordance with various embodiments of the invention;

FIG. 19 comprises a view of an interactive user interface as configured in accordance with various embodiments of the invention;

FIG. 20 comprises a view of an interactive user interface as configured in accordance with various embodiments of the invention;

FIG. 21 comprises a view of an interactive user interface as configured in accordance with various embodiments of the invention;

FIG. 22 comprises a view of an interactive user interface as configured in accordance with various embodiments of the invention;

FIG. 23 comprises a view of an interactive user interface as configured in accordance with various embodiments of the invention;

FIG. 24 comprises a view of an interactive user interface as configured in accordance with various embodiments of the invention;

FIG. 25 comprises a view of an interactive user interface as configured in accordance with various embodiments of the invention; and

FIG. 26 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides a hierarchically structured knowledge base containing hierarchically ordered data elements. One also provides an interactive user interface, wherein the interactive user interface is operably coupled to the hierarchically structured knowledge base. One then generates a set of data-entry forms that are displayable on the interactive user interface using the hierarchically structured knowledge base, wherein each data-entry form contains a plurality of data-entry columns of data-entry opportunities.

In one preferred but optional approach, the data-entry opportunities include all of the data-items in a sub-hierarchy of the hierarchically structured knowledge base. In another preferred but optional approach, the data-item opportunities include only a subset of the data-items in a sub-hierarchy of the hierarchically structured knowledge base. Pursuant to another preferred but optional approach, the data-entry opportunities are not necessarily ordered in a manner conforming to the hierarchical order that characterizes the hierarchically structured knowledge base. Combining these approaches, in one preferred but optional approach, the data entry-opportunities are selected from throughout the hierarchically structured knowledge base and placed on the data-entry form in an order that is independent of their order in the knowledge base. Further, in another preferred but optional approach, the data-entry opportunities and the order of these data-entry opportunities on the data-entry form are based on the requirements of human medical condition syndrome-based reporting needs rather than upon their relative position within the hierarchically structured knowledge base.

Pursuant to a preferred but optional approach, one dynamically generates the data-entry form in response to detecting, via the interactive user interface, that a user needs to enter data using the interactive user interface. In one preferred but optional approach, the dynamic creation of the data-entry form is initiated by an element of the interactive user interface that lies outside of the set of data-entry forms. In another preferred but optional approach, the dynamic creation of the data-entry form is initiated by the user interacting with a navigational data-entry opportunity on another data-entry form. Also pursuant to another preferred but optional approach, one displays, via the interactive user interface, at least a portion of a given data-entry opportunity in conjunction with a non-alphanumeric graphic element.

Pursuant to a preferred but optional approach, at least one of the data-entry opportunities consists of a multi-entry data-entry opportunity. In another preferred but optional approach, at least one of the data-entry opportunities consists of a non-alphanumeric graphic element.

The plurality of data-entry columns of data-entry opportunities contained by the data-entry form permits the user to view a large number of data-entry opportunities at the same time via the interactive user interface. Generally, the data-entry opportunities are arranged vertically within each data-entry column and data-entry columns are generally arranged horizontally with respect to each other. This orientation permits a large number of data-entry opportunities to be presently in view via the interactive user interface at any given time. Additionally, the horizontal orientation of the data-entry columns can typically permit a user to more easily see data-entry columns that may be partially in view via the interactive user interface. This permits the user to be aware of the existence of data-entry opportunities not presently in view via the interactive user interface and to be aware of an ability to horizontally scroll to bring data-entry opportunities into full view via the interactive user interface.

Collectively, the set of generated data-entry forms provide access to the entire data set underlying the hierarchically structured knowledge base and do so in a manner that brings important data elements to the forefront by placing corresponding data-entry opportunities directly and prominently on a data-entry form while providing the user with the ability to navigate via navigational data-entry opportunities to secondary data-entry forms. Also, the contents and organization of the data-entry forms can be set to match what the user seeks (or needs) to enter and how the user sees the data rather than matching how the underlying data set is organized for storage and retrieval. This contrasts with the methods for entering hierarchically ordered data in existing art, in which the data-entry mechanisms mirror the organization of the underlying data set.

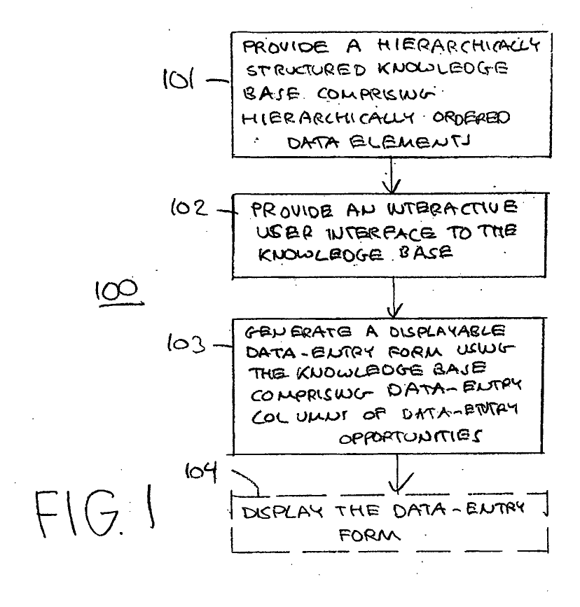

These and other benefits may become clearer upon making a thorough review and study of the following detailed description. Referring now to the drawings, and in particular to FIG. 1, a corresponding process 100 will be described.

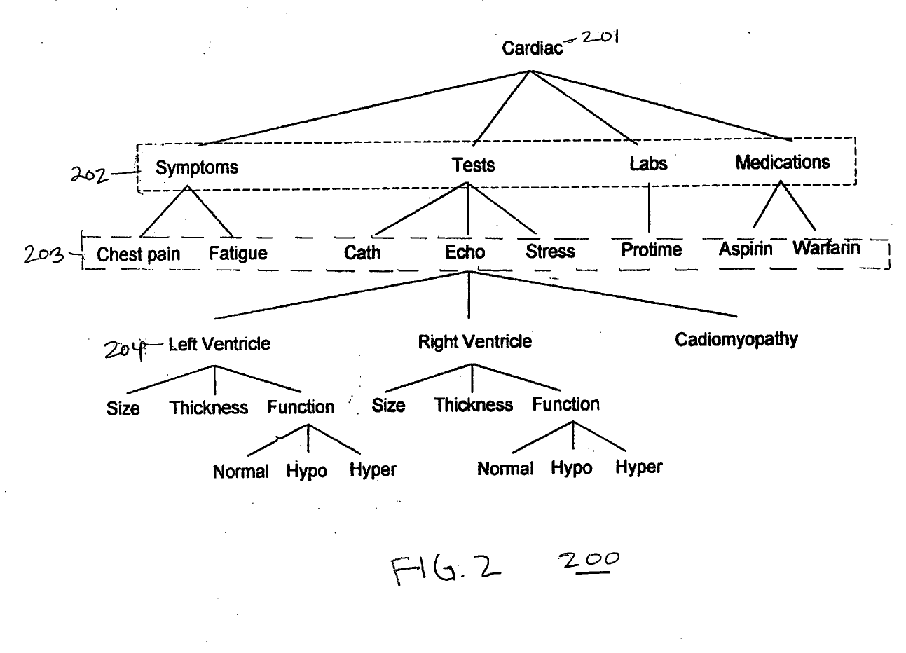

This process 100 preferably provides 101 a hierarchically structured knowledge base that is itself comprised of hierarchically ordered elements. For example, and referring momentarily to FIG. 2, the hierarchically structured knowledge base may be composed of hierarchically ordered elements as denoted, for example, by reference numerals 201 and 204. In the particular view shown, element “Cardiac” 201 represents the root of this specific hierarchy 200. Elements (i.e., “Symptoms,” “Tests,” “Labs,” and “Medications”) are then seen to comprise a second level 202 of this hierarchy 200 while a next series of elements (i.e., “Chest pain,” “Fatigue,” “Cath,” “Echo,” “Stress,” “Protime,” “Aspirin,” and “Warfarin”) are seen to comprise a third level 203 of the hierarchy 200. So configured, it can be readily observed that elements from these various hierarchical layers are placed, relative both to the root element 201 and to one another, in a specific hierarchical order. It will further be observed that, in a typically embodiment, each element of each hierarchical layer will not necessary correspond to each element of the preceding and subsequent layers. For example, in this illustration, the element “Tests” in the first layer 202 is seen to correspond to the elements “Cath,” “Echo,” and “Stress” of the second layer 203 but not to the other elements of that second layer 203.

Referring back now to FIG. 1, this process 100 may also provide 102 an interactive user interface that is operably coupled to the aforementioned hierarchical knowledge base. This process 100 may then also generate 103 a displayable data-entry form using the hierarchically structured knowledge base, wherein the data-entry form comprises a plurality of data-entry columns of data-entry opportunities. This process then optionally though preferably displays 104 the data-entry form via the interactive user interface.

Those skilled in the art will appreciate that the above-described process is readily enabled using any of a wide variety of available and/or readily configured platforms, including partially or wholly programmable platforms as are known in the art or dedicated purpose platforms as may be desired for some applications. It will further be understood and appreciated that such a process can be readily facilitated in a wholly local fashion or may be supported by remotely located cooperating platforms via, for example, an intervening communication network of choice. As such platforms and interfaces are generally well-understood in the art, and further as these teachings are not particularly sensitive to the selection of any particular platform and/or display, for the sake of brevity further elaboration regarding such elements will not be provided here.

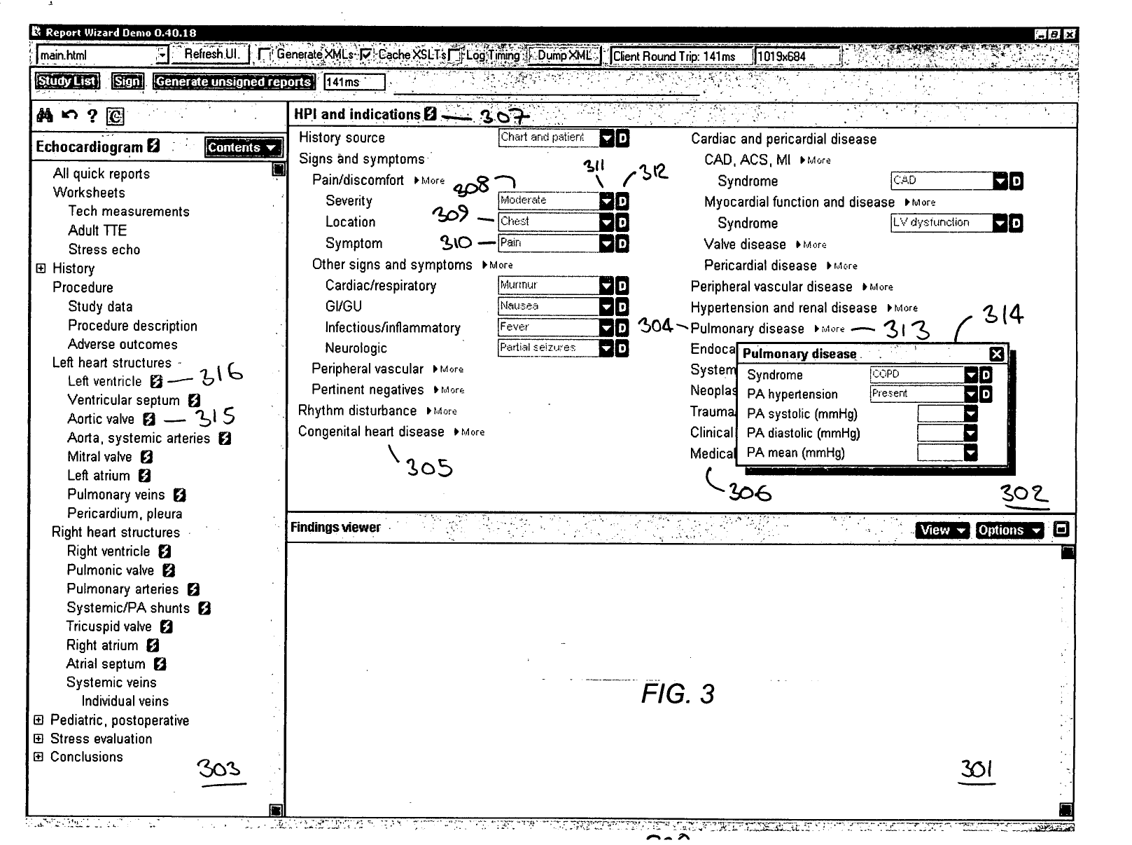

Referring now to FIG. 3, in a preferred configuration the interactive user interface 300 comprises a display that presents a findings viewer 301, a worksheet viewer 302, and a navigation frame 303 in segregated windows. The findings viewer 301 serves in this embodiment to display data entry content as a user enters data into data-entry opportunities that are offered in the worksheet viewer 302 as described in more detail below. In this view the findings viewer 301 is currently empty because the user has not yet made any such data entries.

The worksheet viewer 302 in this illustrative embodiment displays a plurality of data-entry columns 305, 306 (with two such columns being illustrated in FIG. 3) wherein each data-entry column 305,306 is comprised of a plurality of data-entry opportunities (such as, for example, a data-entry opportunity to enter information regarding the “severity” 308 of pain/discomfort, the “location” 309 of such pain/discomfort, and a corresponding “symptom” 310 with numerous other examples being shown as well). In this embodiment a particular data-entry opportunity may contain a drop-down capability 311. A user may select such a drop-down capability 311 to display a corresponding list of pre-characterized or predefined data elements that are available to populate that data-entry opportunity. This embodiment also provides for a default button 312. The default button 312 allows the user to populate the corresponding data-entry opportunity with a default data value by simply clicking on the default button 312.

In this illustrative embodiment the worksheet viewer 302 may also provide a link 313 in conjunction with each of one or more of the data-entry opportunities. For example, the illustrated “Pulmonary disease” data-entry opportunity 304 has a navigational link 313 captioned “More” provided adjacent thereto. A user can select this link 313 to thereby cause a display a secondary data-entry form 314 containing additional data-entry opportunities related specifically to “Pulmonary disease”.

The navigation frame 303 in this embodiment displays a plurality of so-called finding groups (such as, for example, the finding group entitled “aortic valve” 315 and another entitled “left ventricle” 316). The layout of these finding groups will preferably correlate to sub-hierarchies in the aforementioned hierarchical knowledge base and in particular can reveal at least aspects of that hierarchical structure via, for example, a nested or outline style of content presentation.

In this embodiment each such finding group will typically correlate to a particular data-entry form to be displayed in the worksheet viewer 302. So configured, when the user selects a particular finding group the worksheet viewer 302 displays a corresponding correlated data-entry form. In a preferred approach the title of such a user-selected finding group is displayed at the top 307 of the worksheet viewer 302. The layout of this data-entry form will preferably correlate to the associated sub-hierarchy in the aforementioned hierarchical knowledge base and in particular can reveal aspects of that hierarchical structure via, for example, a nested or outline style presentation of the data-entry opportunities. Note, however, that these data-entry opportunities preferably include only a subset of the data-items in the associated sub-hierarchy—typically, the most important or the most useful. The remaining data-items can be reached via navigational data-entry opportunities (e.g., the aforementioned illustrative “Pulmonary disease ” data-entry opportunity 304) which bring up secondary data-entry forms containing the additional elements of the sub-hierarchy. The above description provides an overview of a preferred structure and configuration of an interactive user interface as is suitable for use in conjunction with these teachings. Additional details and options will now be presented via a series of additional examples.

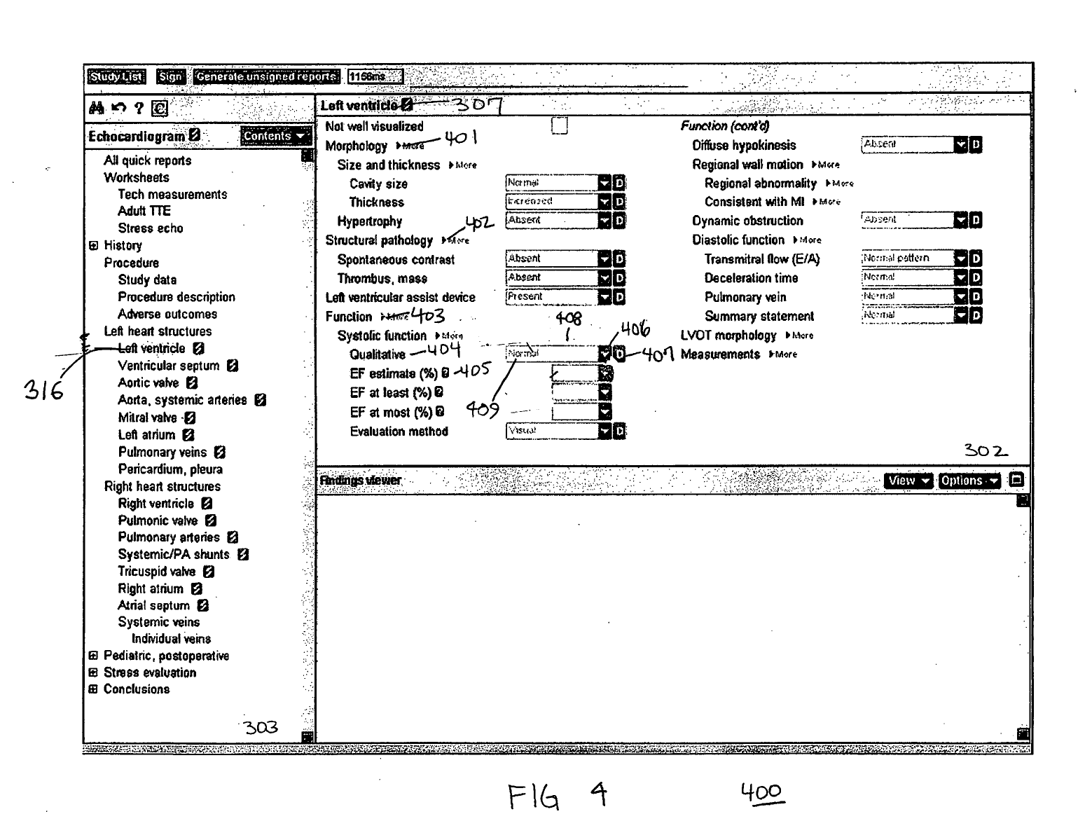

Referring now to FIG. 4, a present view 400 of the interactive user interface reveals that the user has selected the “left ventricle” finding group 316 in the navigation frame 303. This has caused, in turn, a display of the corresponding data-entry form in the worksheet viewer 302. The title of the selected finding group 316 is displayed at the top 307 of the worksheet viewer 302. Viewed hierarchically, some of the data-entry categories (such as the “morphology” 401, “structural pathology” 402, and “function” 403 data-entry opportunities) are relatively higher level data categories for which a user can enter data via the data-entry form. In turn, some of the data-entry categories (such as the “qualitative” 404 and “EF estimate” data-entry categories 405) are sub-categories of a higher order data-entry category (though again comprise data categories for which a user can enter data).

In the case of such sub-categories, in this embodiment, the data entry activity can be effected through use of corresponding data-entry opportunities (such as the data-entry opportunity 408 as corresponds to the “qualitative” 404 data-entry category which can be populated through a corresponding drop-down capability 406 or by selecting a corresponding default value of “Normal” 409 using the default value button 407 as described above).

So configured, those skilled in the art will recognize and appreciate that a user can navigate through various data-entry categories as are hierarchically presented in the navigation frame 303. Selection of a particular data-entry category from the navigation frame 303 will in turn cause automatic selection and presentation of a corresponding multi-column data-entry form in the worksheet viewer 302. These columns are preferably comprised of a plurality of data-entry opportunities that offer, at least in some cases, various ways by which a user can enter data.

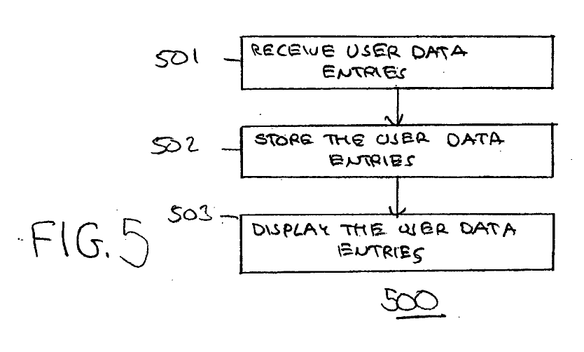

Referring now to FIG. 5, a general process 500 to facilitate such data entry will be described. Pursuant to this process one receives 501 (preferably via an interactive user interface) a user's data entries. These data entries are stored 502 and, in a preferred approach, displayed 503 as well. Some illustrative examples that accord with this process 500 will now be presented.

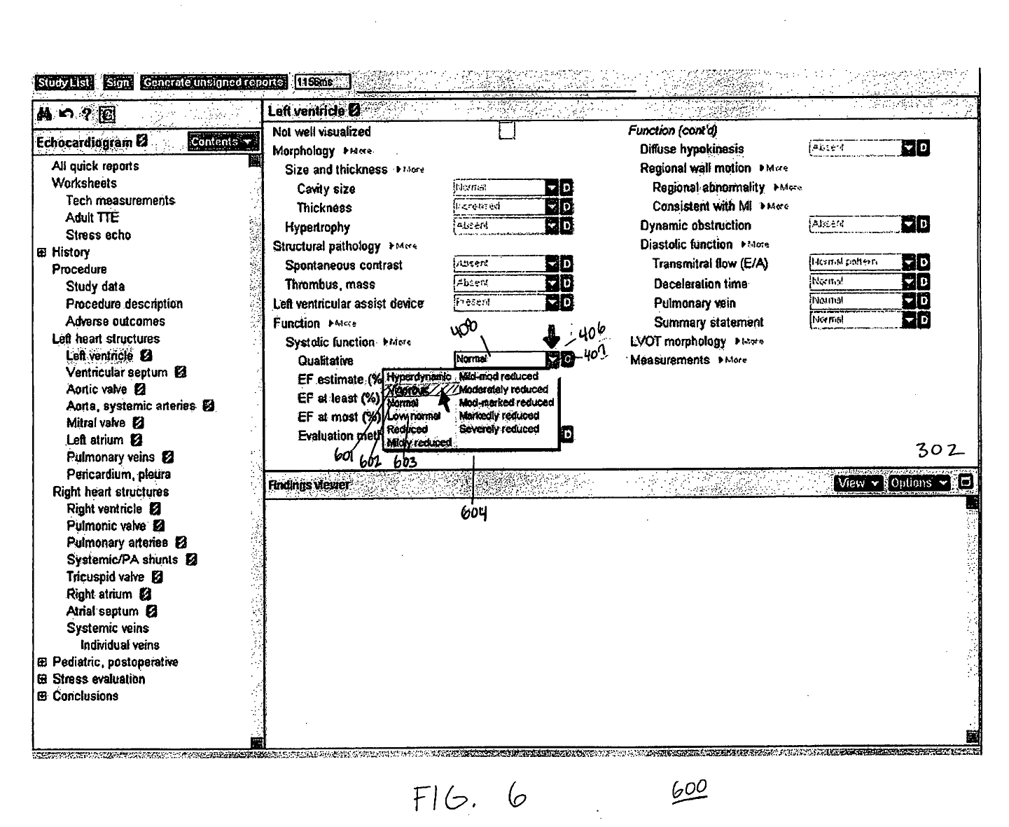

Referring now to FIG. 6, in illustrated present view 600 of the interactive user interface the user is effecting a data entry via the worksheet viewer 302. In this example the user selects the previously mentioned drop-down capability 406 that corresponds to the “qualitative” data-entry opportunity 408. In response a corresponding box 604 appears that contains a list of user-selectable pre-defined data elements including “vigorous” 601, “normal” 602, and “low normal” 603 to note but a few. In this example the user selects the “vigorous” data element 601 to populate the “qualitative” data-entry opportunity 408. As per the above-described processes this data entry event is stored upon receipt.

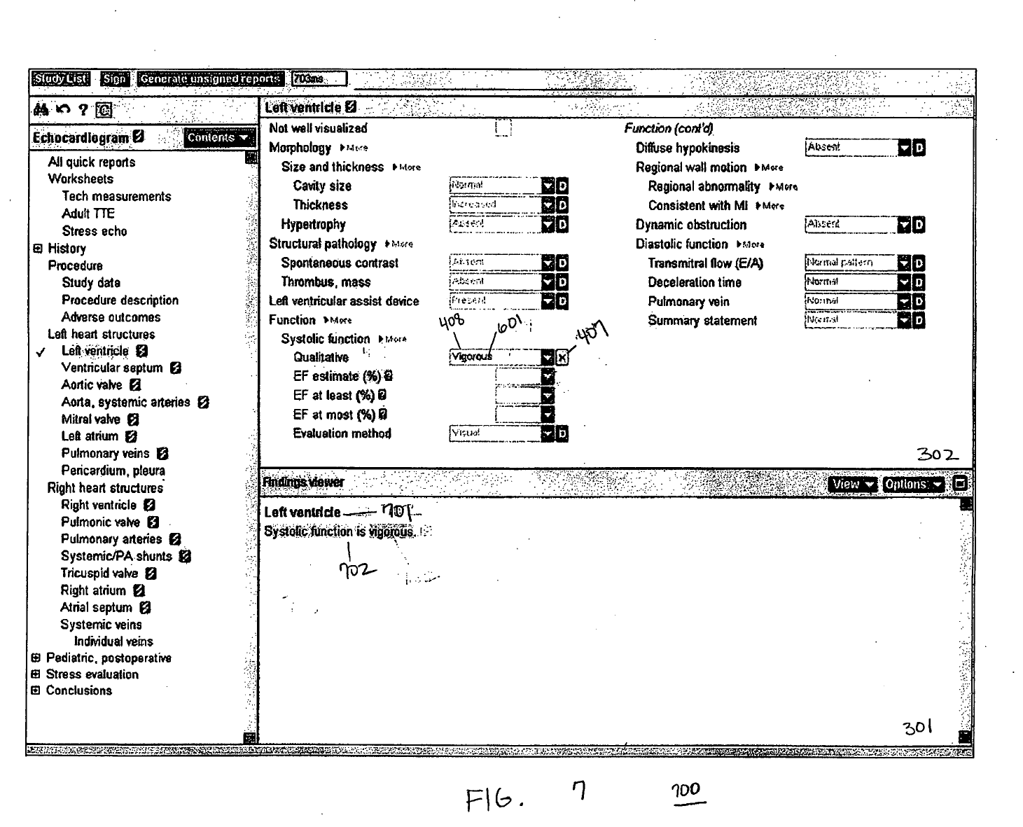

Referring now to FIG. 7, the data element 601 selected by the user now populates the “qualitative” data-entry opportunity 408 with the corresponding data-result being displayed via the worksheet viewer 302 in the present view 700 of the interactive user interface. As this data-entry opportunity 408 has now been populated by a specific action taken by the user, if desired the corresponding default value button 407 can be inactivated. Also if desired, upon inactivating the default value button 407 the default value button 407 itself can be altered in appearance to indicate its inactive status. The present view 700 of this illustrative example also reveals that the findings viewer 301 now displays text comprising the title 701 of the finding group for which the user is currently entering data (i.e., “Left ventricle”) and text 702 relating to the just-described user's data-entry 601 in the data-entry opportunity 408 (i.e., “Systolic function is vigorous.”).

Those skilled in the art will recognize and appreciate that the displayed text 702 (“Systolic function is vigorous.”) does not accord exactly with the user's data entry. That is, the user entered “vigorous” as a data entry for the data-entry opportunity that corresponds to a qualitative measure of the systolic function of the left ventricle. The findings viewer 301 is presenting a somewhat translated version of that data entry; in particular, the findings viewer 301 presents a more natural language version of the data entry. This natural language version, in turn, comprises a report that is readily and easily read and assimilated by a human observer. Templates and other syntax and grammatical processes and engines to effect such a translation are known in the art and require no further explanation here.

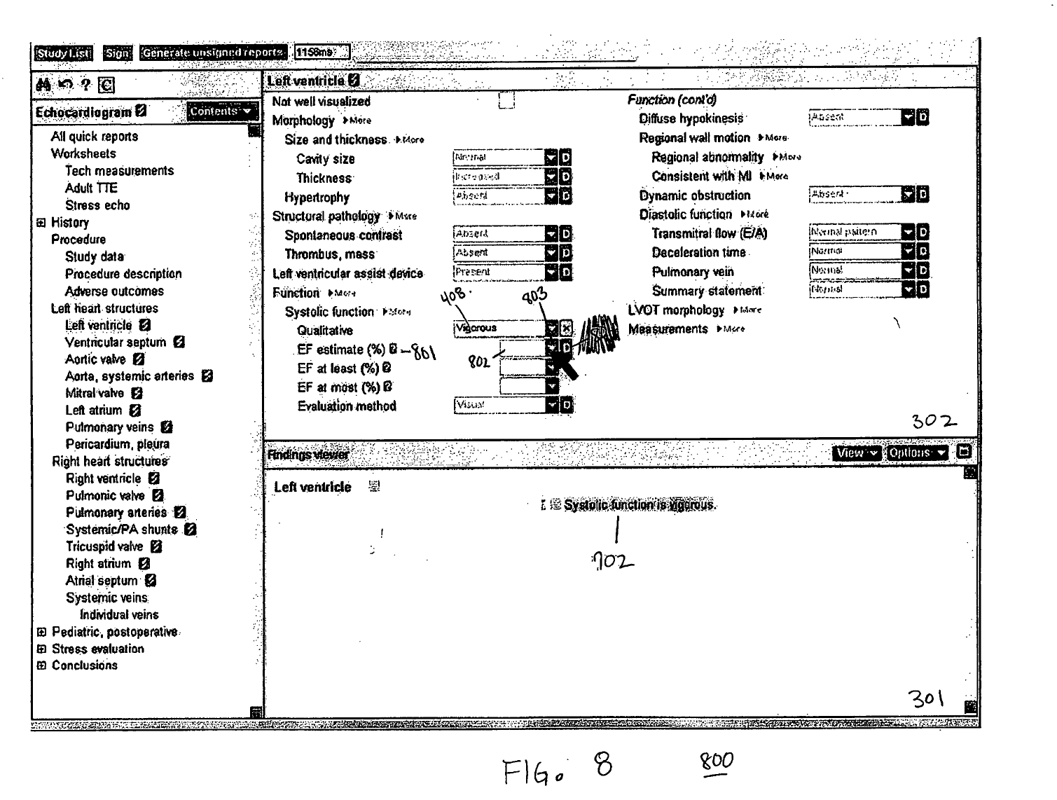

Referring now to FIG. 8, in this present view 800 of the interactive user interface the user selects the drop-down capability 803 that corresponds to another data-entry opportunity 802 which corresponds to a different data-entry category (the “EF estimate (%) data-entry category) 801. It may be noted that the findings viewer 301 continues to display the text 702 that corresponds to the user's data-entry for the previously described data-entry opportunity 408.

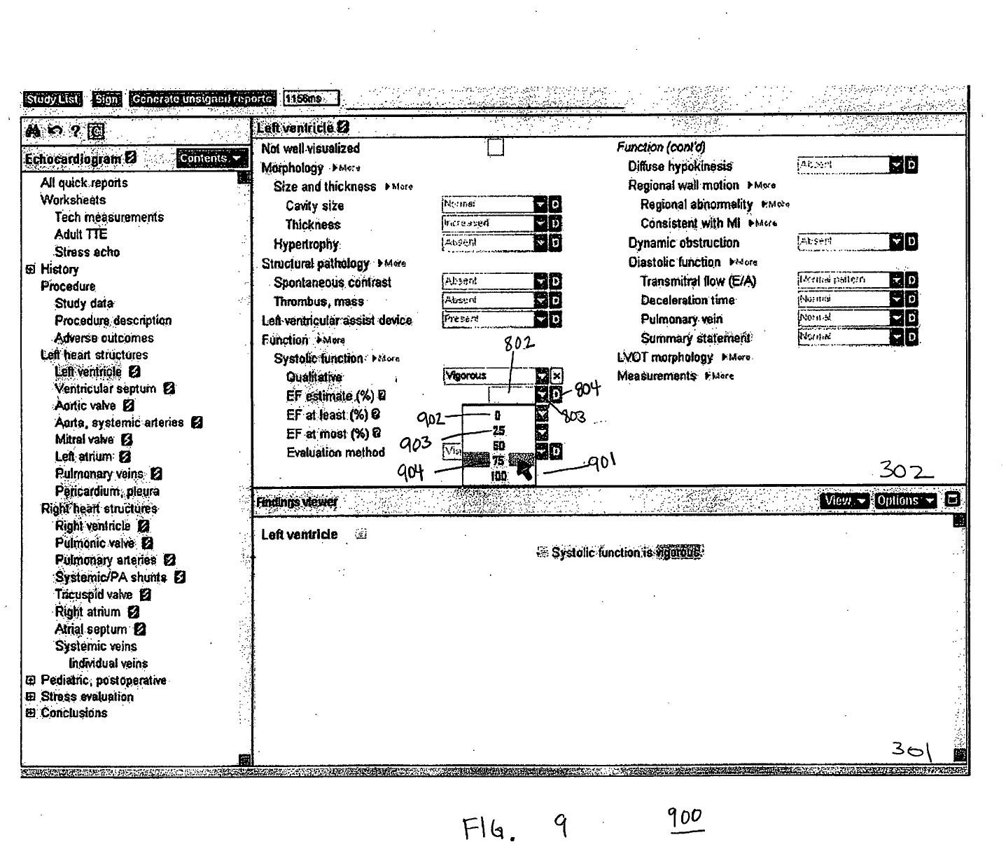

As before, and referring now to FIG. 9, a box 901 will appear containing a list of selectable predefined data elements (including, in this examples, specific numeral values such as “0” 902, “25” 903, and “75” 904) from which the user can select a specific data element to populate the data-entry opportunity 802 that corresponds to the “EF estimate (%) data-entry” category. Alternatively, the user can enter a numeric value directly into this data-entry opportunity 802 using an alternative mechanism such as, for example, a workstation keyboard, an on-screen numeric keypad, or a voice-recognition software interface (not shown). In this example the user selects the “75” data element 904 to populate the data-entry opportunity 802.

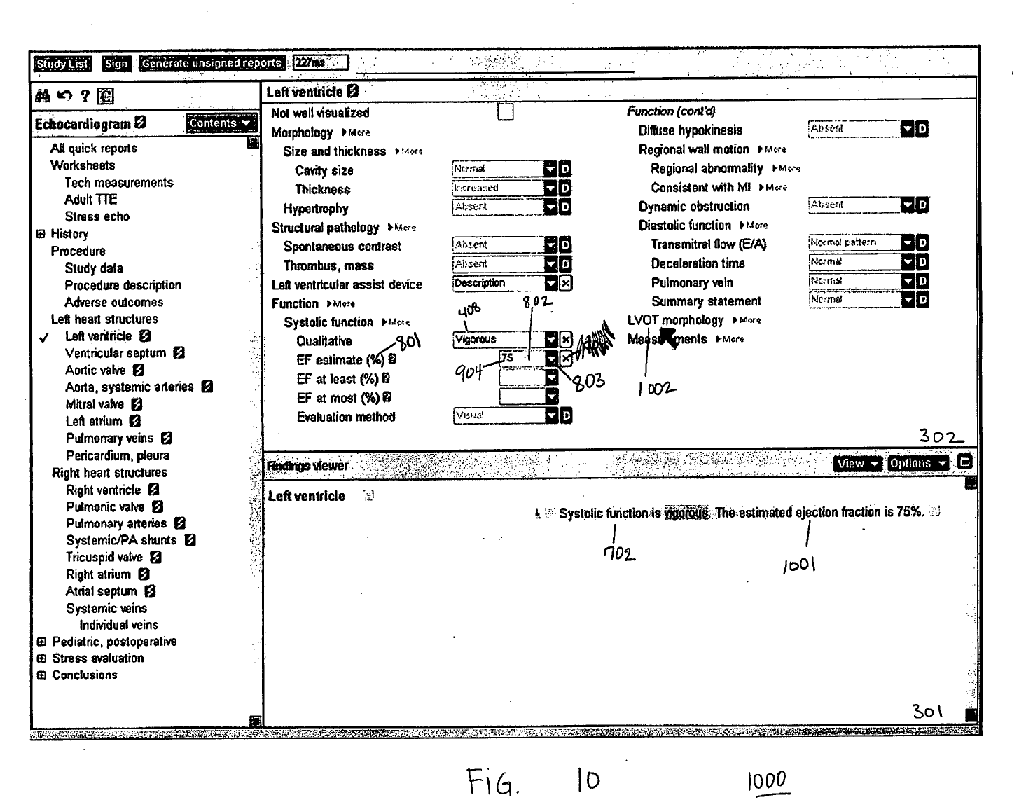

Again as before, and referring now to FIG. 10, such data entry content is stored upon receipt. The specific entered value (“75”) 904 now appears in the corresponding data-entry opportunity 802. In addition, the new data entry material is again translated into a natural language presentation 1001 (i.e., “The estimated ejection fraction is 75%.”) that corresponds to this data entry event and this natural language presentation 1001 is again displayed in the findings viewer 301 as shown in the present view 1000 of the interactive user interface.

Those skilled in the art will recognize and understand that, pursuant to this particular illustrative embodiment, the findings viewer 301 continues to display the previously presented text 702 (i.e., “Systolic function is vigorous”) corresponding to the user's data-entry in the previous data-entry opportunity 408 and now also displays text 1001 (i.e., “the estimated ejection fraction is 75%”) corresponding to the user's data-entry in the subsequent data-entry opportunity 802. In an optional though preferred approach, the order of presentation for the natural language text is derived as a function of the order in which the data-entry opportunities are presented rather than in the order by which a user may elect to enter the specific data items.

As noted earlier, in a preferred approach not every displayed data-entry category has a corresponding data-entry opportunity comprising an obvious data-entry field as appears in the above two examples. In some cases, if desired, the data-entry opportunity for a given data-entry category can comprise a link to a secondary data-entry opportunity. For example, the data-entry opportunity 1002 as corresponds to the data-entry category “LVOT morphology” comprises such a link.

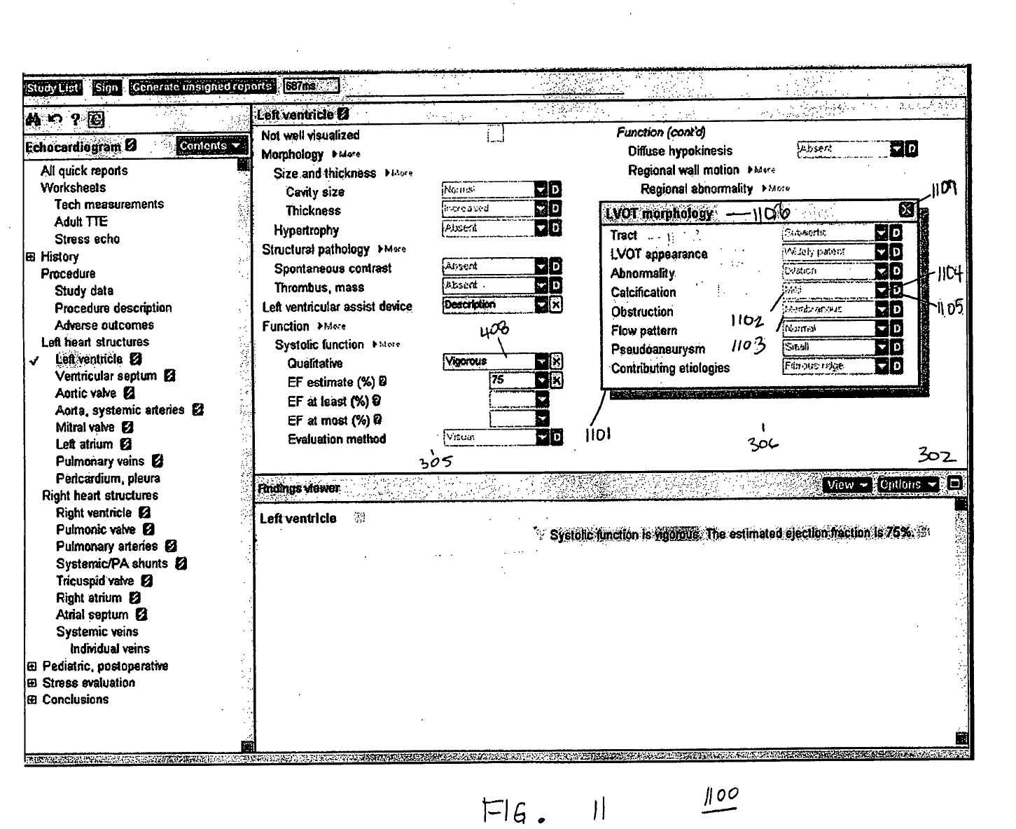

When the user selects such a particular data-entry opportunity 1002, and referring now to FIG. 11, a secondary data-entry opportunity comprising a data-entry form 1101 is displayed in the worksheet viewer 302, as can be seen in the present view 1100 of the interactive user interface. In this illustrative example, the secondary data-entry form 1101 partially overlies the original data-entry form displayed in the worksheet viewer 302. The secondary data-entry form 1101 may contain a plurality of data-entry opportunities (such as, for example a data-entry opportunity 1102 associated with the concept of “calcification” or another data-entry opportunity 1103 associated with the concept of “obstruction”). In a preferred though optional approach these data-entry opportunities may be configured similarly to the previously described data-entry opportunities. Accordingly, these data-entry opportunities may again contain a drop-down capability 1104 and/or a default value button 1105 similar to those described above.

In a preferred approach, the title of the original data-entry opportunity (i.e., “LVOT morphology”) is displayed at the top 1106 of the secondary data-entry form 1101. The secondary data-entry form 1101 can preferably be closed by the user using a corresponding button 1107 located, in this embodiment, at the upper right hand corner of the secondary data-entry form 1101.

So configured, those skilled in the art will recognize and appreciate that a relatively large number of candidate data-entry opportunities can be provided to a user in a manner that does not needlessly overcrowd the primary display. Those skilled in the art will recognize and understand as well that, if desired, one or more of the data-entry opportunities as presented in such a secondary data-entry form can itself lead to yet a further nested data-entry form or opportunity.

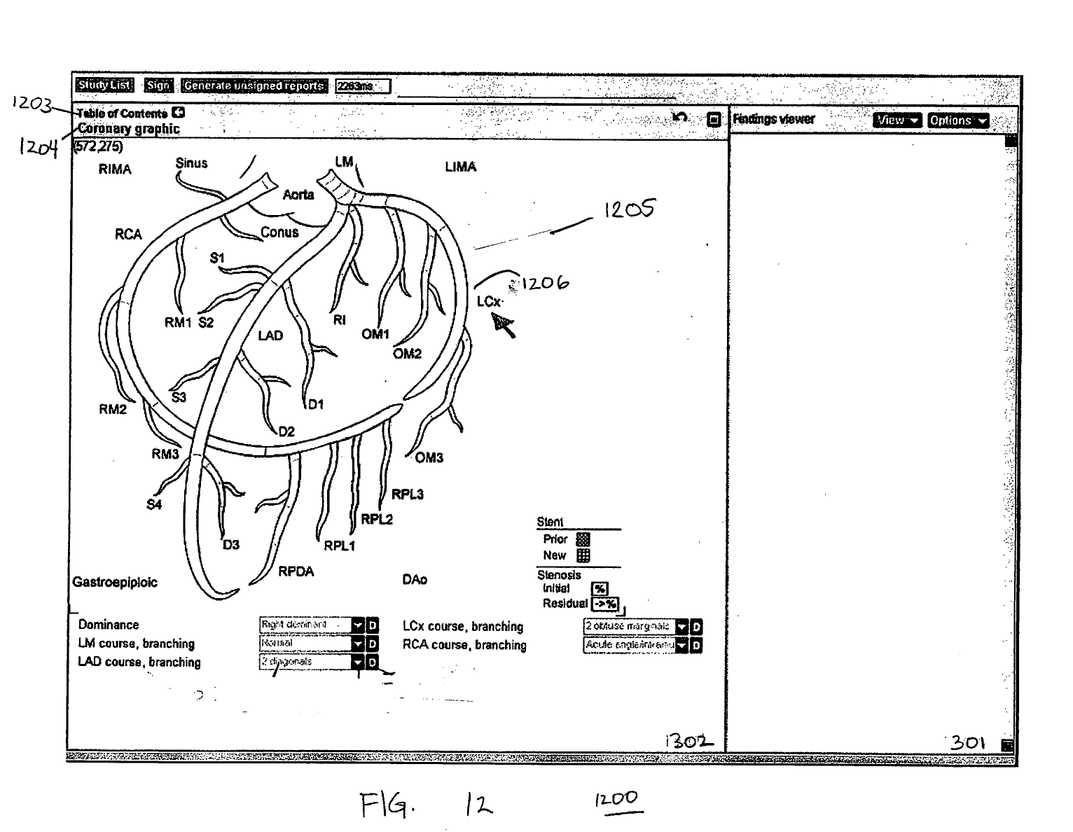

In the examples provided above the data-entry opportunities comprise, generally speaking, alphanumeric data-entry opportunities. In a preferred embodiment, the worksheet viewer 302 can also display a non-alphanumeric graphic element as part of the data-entry form. To illustrate, and referring now to FIG. 12, the present view 1200 of the interactive user interface comprises a data-entry form entitled “Coronary graphic” 1204 comprising a non-alphanumeric graphic element 1205. In part to accommodate this non-alphanumeric graphic element 1205 the navigation frame has been closed or occluded. The user can still bring the navigation frame into view, if desired, by selecting a link 1203 labeled, in this embodiment, “Table of Contents” at the top of the worksheet viewer 302.

In this embodiment various data-entry opportunities are embedded within the non-alphanumeric graphic element 1205 (the latter comprising, in this example, an illustration of various coronary arteries).

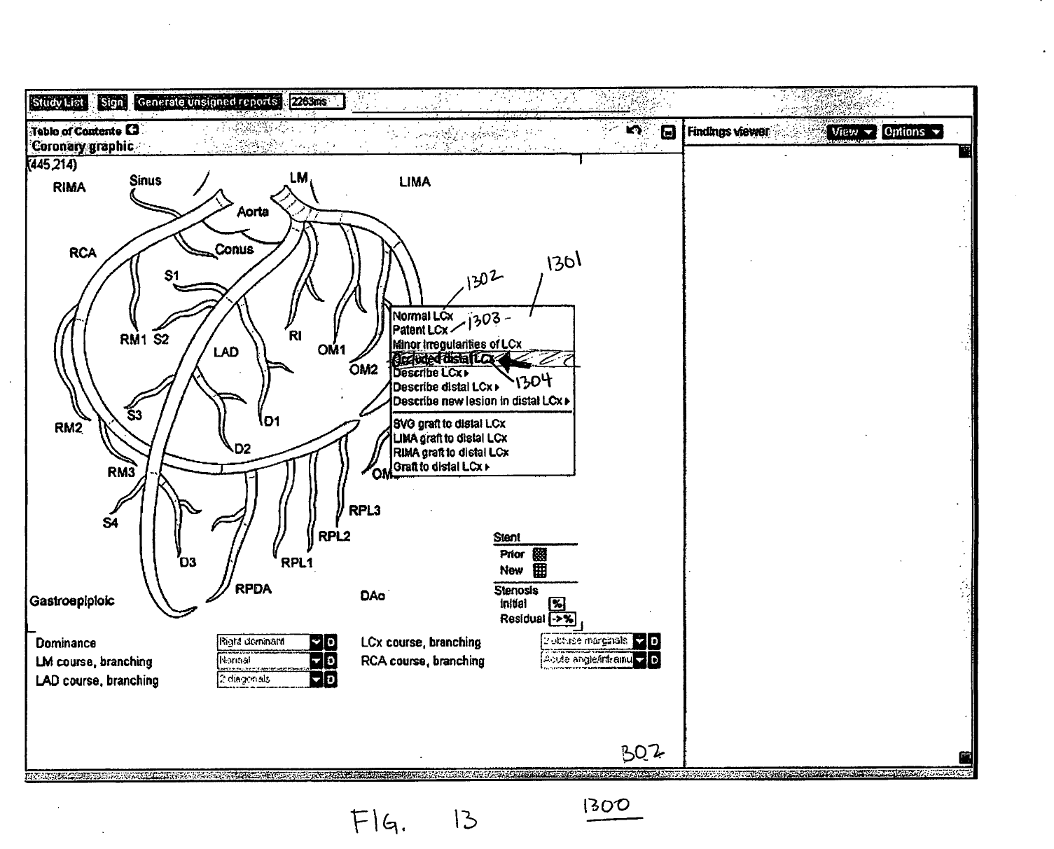

Each of the vessel segments in the coronary diagram 1205 comprise, effectively, a data-entry opportunity. For example, one such vessel segment 1206 is a link to a set of data-entry opportunities for descriptors of the distal left circumflex (“distal LCx”) coronary vessel. When the user selects this data-entry opportunity by clicking on this vessel segment 1206, and referring now to FIG. 13, a present view 1300 of the interactive user interface will reveal a display of a box 1301 containing a list of selectable predefined data elements (such as, in this example, “normal LCx” 1302, “patent LCx” 1303, and “occluded distal LCx” 1304) from which the user may select to populate the data-entry opportunity. In this example the user selects the “occluded distal LCx” 1304 data element for entry into the form.

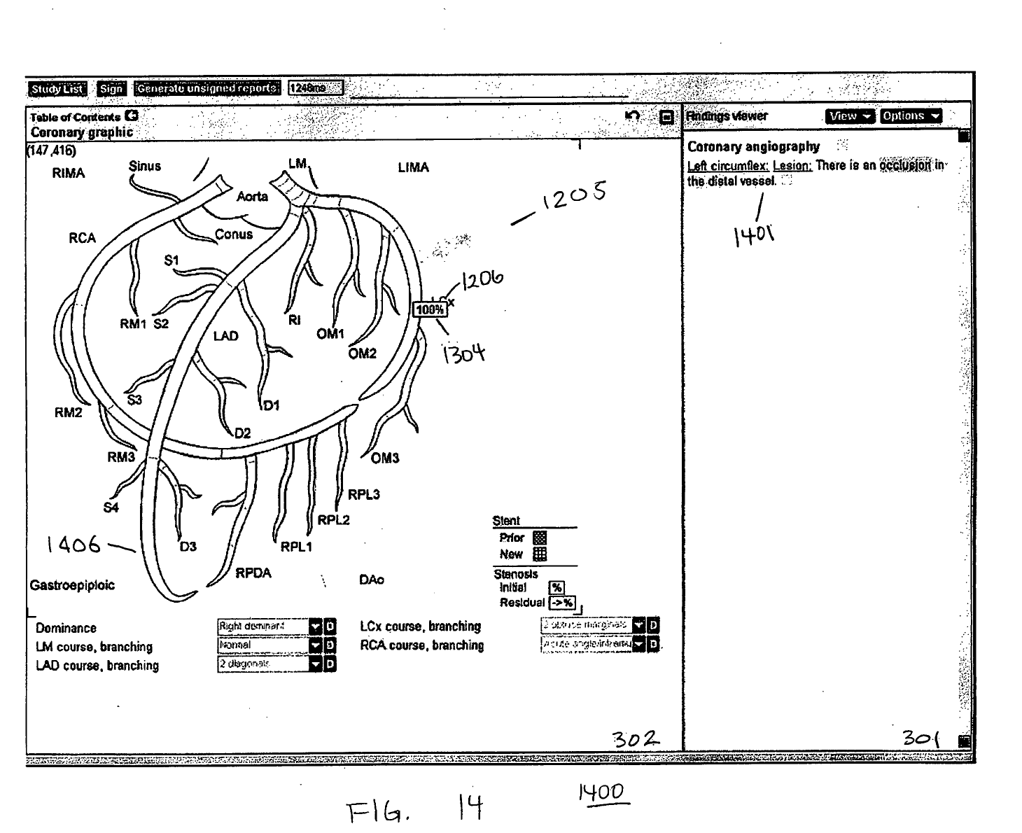

Upon selecting this data element 1304 to populate this data-entry opportunity 1206, and referring now to FIG. 14, a present view 1400 of the interactive user interface depicts the worksheet viewer 302 as displaying a corresponding data-entry 1304 of “100%” in conjunction with the non-alphanumeric graphic element 1205. In particular, this content is positioned in proximity to the distal left circumflex vessel to which it corresponds. So configured, the worksheet viewer 302 now conveys, efficiently and concisely, important information to the reader; i.e., that the patient comprising the subject of these data entries has a fully occluded distal left circumflex coronary vessel. As before, the findings viewer 301 now also displays text 1401 corresponding to the user's data entry 1304 (i.e., in this example, “Left circumflex: Lesion: There is an occlusion in the distal vessel.”

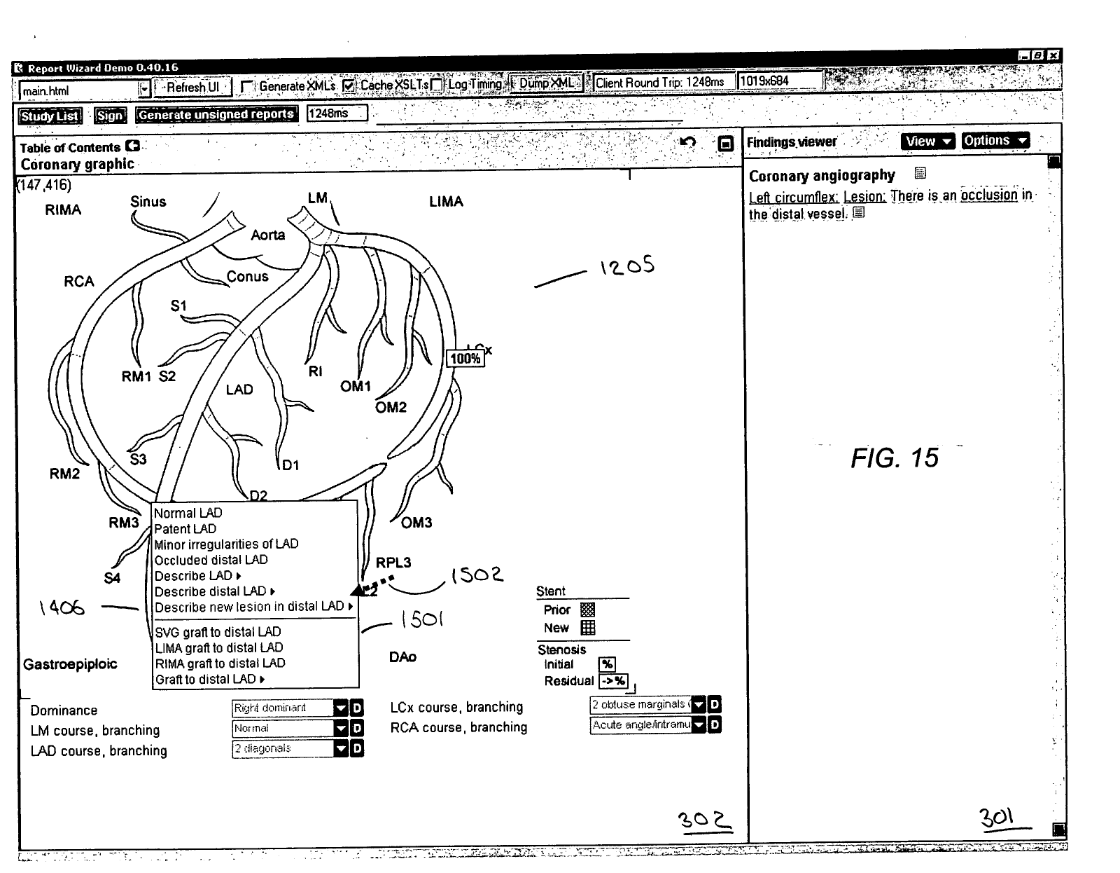

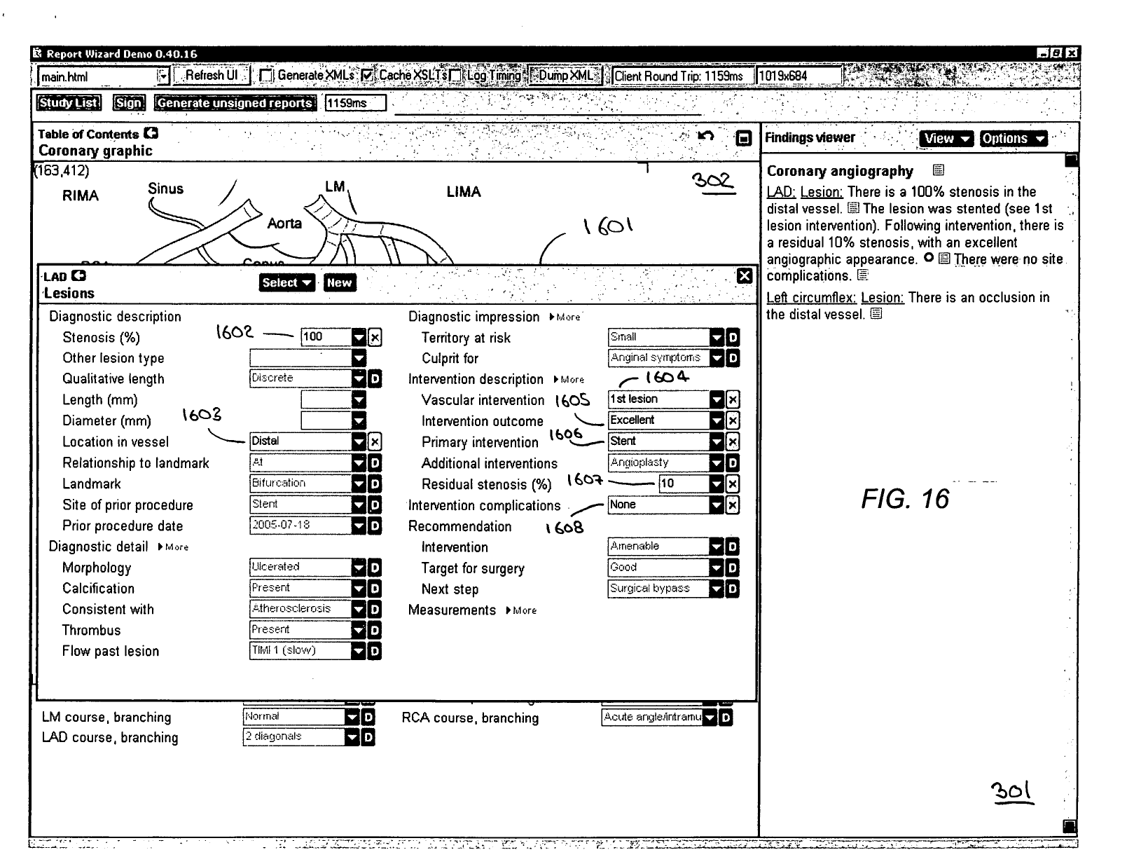

Similarly, the vessel segment denoted by reference numeral 1406 comprises a link to a set of data-entry opportunities for descriptors of the distal left descending (“distal LAD”) artery. Selecting this data-opportunity 1406 triggers the display of a corresponding data-entry form 1501 as shown in FIG. 15. Selecting, for example, “Describe new lesion in the distal LAD” 1502, in turn, displays yet another data-entry form 1601 as shown in FIG. 16 that provides a set of data-entry opportunities that allow a user to enter a complete description of the distal left circumflex.

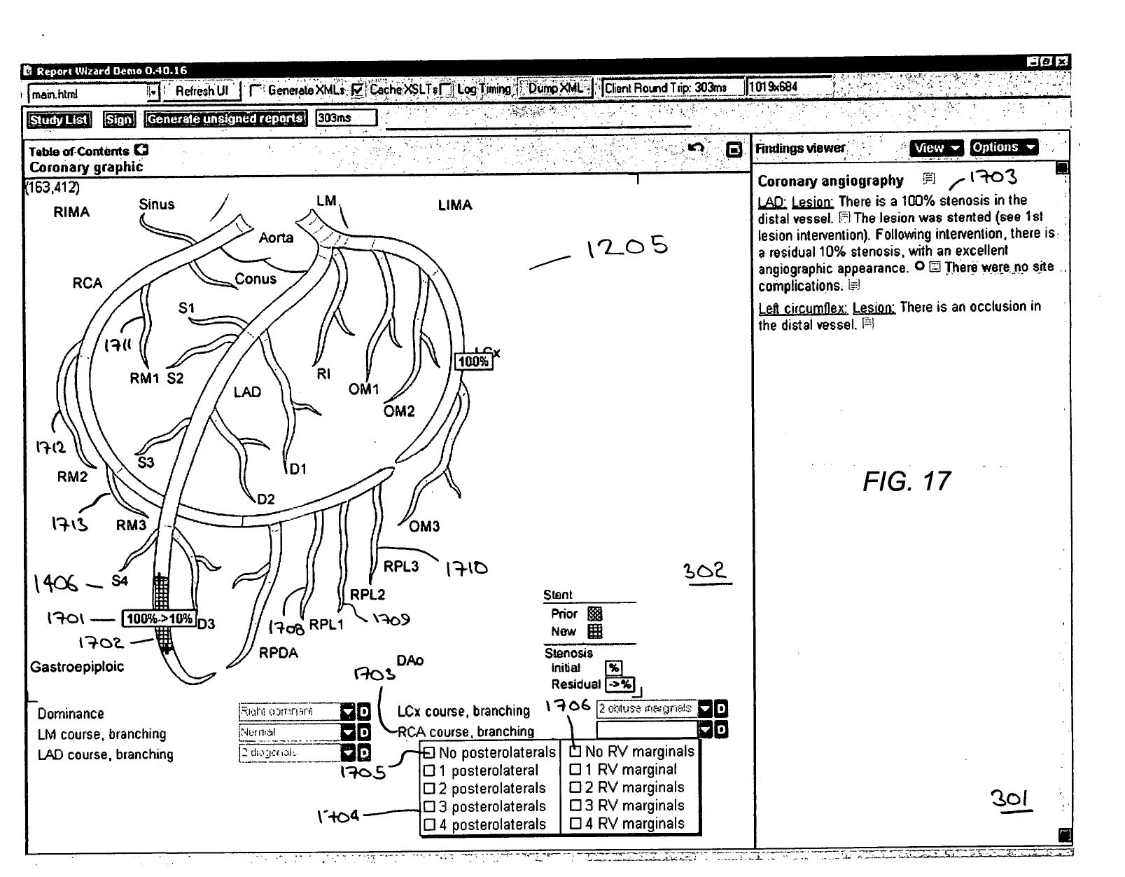

When a user enters data for “stenosis {%}” 1602, “location in vessel” 1603, “vascular intervention” 1604, “intervention outcome” 1605, “primary intervention” 1606, “residual stenosis (%)” 1607, and “intervention complications” 1608 using the data-entry techniques described above, corresponding aforementioned coronary diagram 1205 is updated to depict (see reference numeral 1701 in FIG. 17) the presence of a lesion with a note indicating a 100% stenosis becoming a 10% residual stenosis, as well as the presence of a stent 1702. In addition, the findings viewer 301 is updated to include the associated automatically generated narrative text 1703 “LAD: Lesion: There is a 100% stenosis in the distal vessel. The lesion was stented (see 1st lesion intervention). Following intervention, there is a residual 10% stenosis, with an excellent angiographic appearance. There were no complications.”

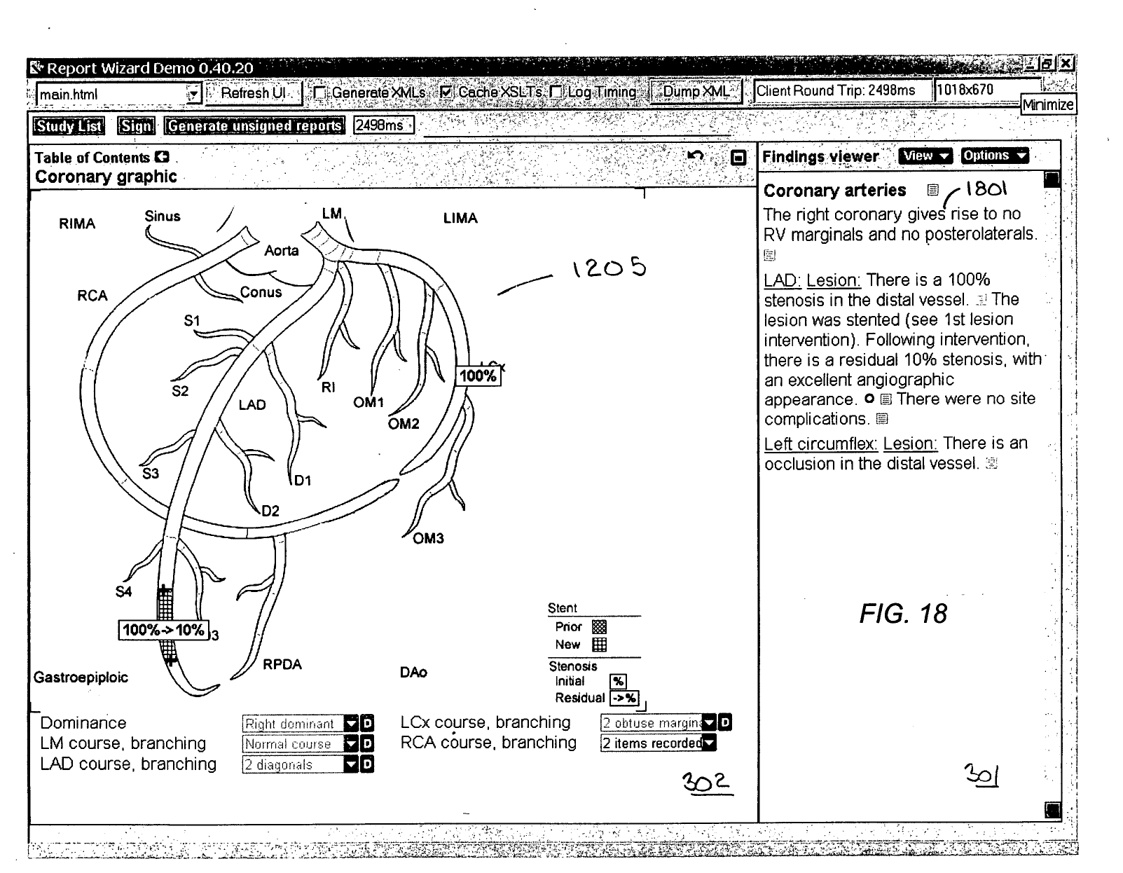

In addition to modifying a graphic image using data entries recorded via graphic data-opportunities, a user can also modify the diagram by entering data into non-graphic, non-diagrammatic data-entry opportunities. For example (and with continued reference to FIG. 17), clicking “RCA course, branching” 1703 opens a drop-down list 1704. In this case, the drop-down list 1704 is a checklist that supports the recording of multiple data items. Selecting both “No posterolaterals” 1705 and “No RV marginals” 1706 will trigger the removal of the following vessels from the diagram: “RPL1” 1708, “RPL2” 1709, “RPL3” 1710, “RM1” 1711, “RM2” 1712, and “RM3” 1713. FIG. 18 depicts this result. In addition, the above action will also cause the addition of the sentence “The right coronary gives rise to no RV marginals and no posterolaterals.” 1801 to the findings viewer 301.

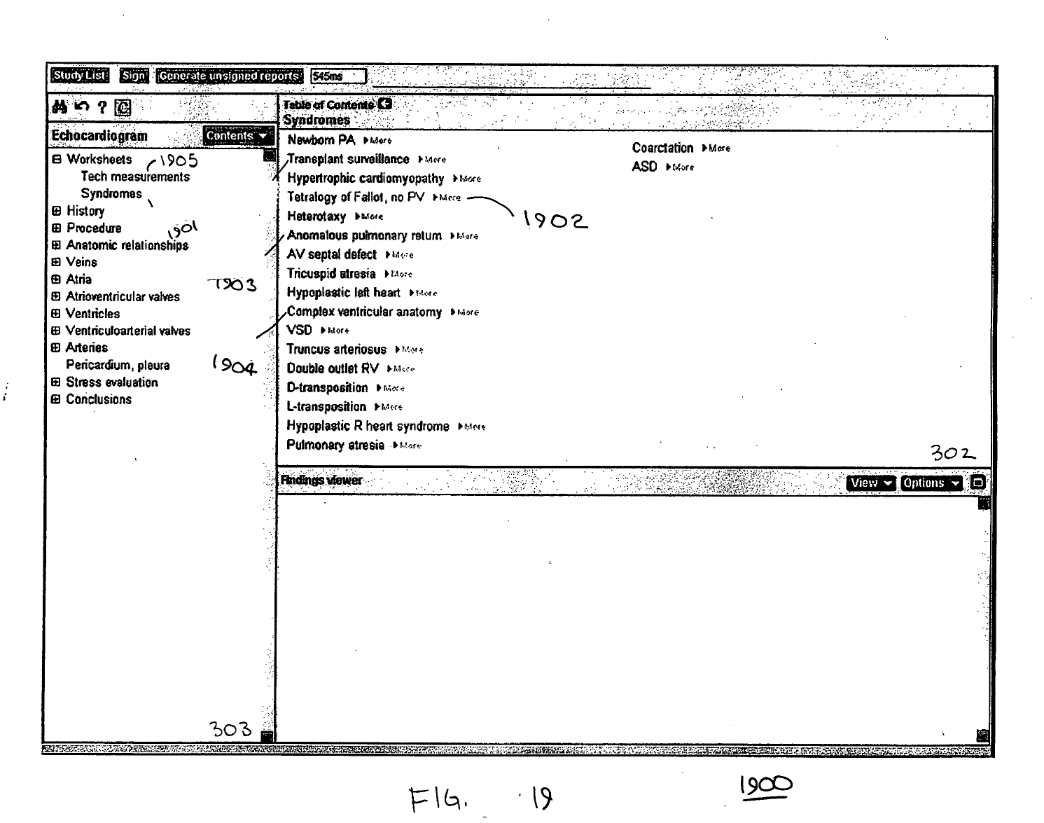

In addition to procedure-based data-entry forms such as those typified above, in a preferred embodiment a user can also choose to generate data-entry forms comprising syndrome-based reporting data-entry forms (where those skilled in the art will understand “syndrome” to refer generally to a group of signs and/or symptoms that collectively indicate or characterize a disease, psychological disorder, or other abnormal condition). For example, and referring now to FIG. 19, a corresponding illustrative view 1900 of the interactive user display permits the user to select to view a set of pediatric cardiac syndromes by selecting a corresponding link 1901 in the navigation frame 303. The worksheet viewer 302 then displays a set of syndromes (such as, for example “Tetralogy of Fallot” 1902, “anomalous pulmonary return” 1903, and “complex ventricular anatomy” 1904) for which a corresponding data-entry form can be generated and displayed.

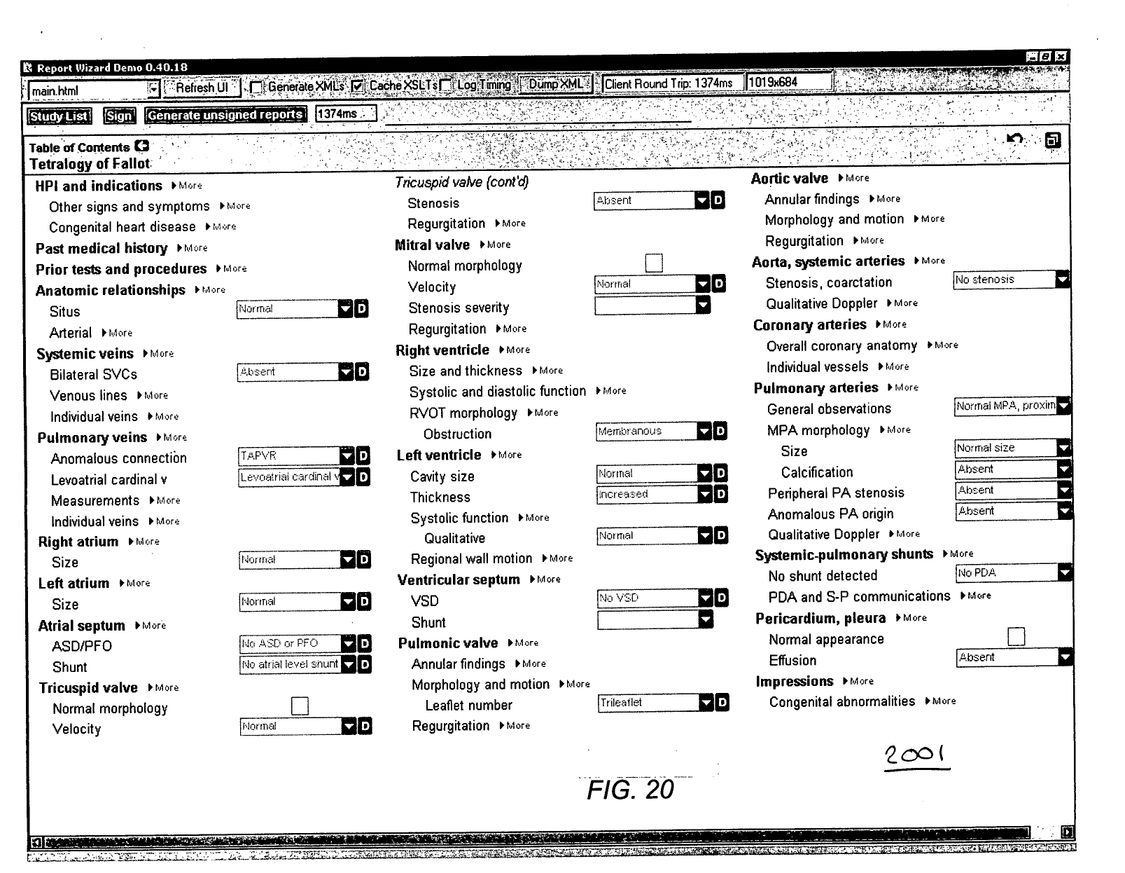

A user may select a syndrome such as Tetralogy of Fallot 1902 from this displayed list to effect generation of a corresponding data-entry form and display of a resultant data-entry form 2001 in the worksheet viewer 302 as depicted in FIG. 20. Note that this data-entry form 2001 presents a set of data-entry opportunities that are especially germane to the syndrome “Tetralogy of Fallot”. These data-entry opportunities are drawn from throughout the previously mentioned knowledge base. Those skilled in the art will appreciate that collecting these potentially disparate yet syndrome-related data-entry opportunities in a single form greatly simplifies the entry of information related to a pediatric patient with this syndrome.

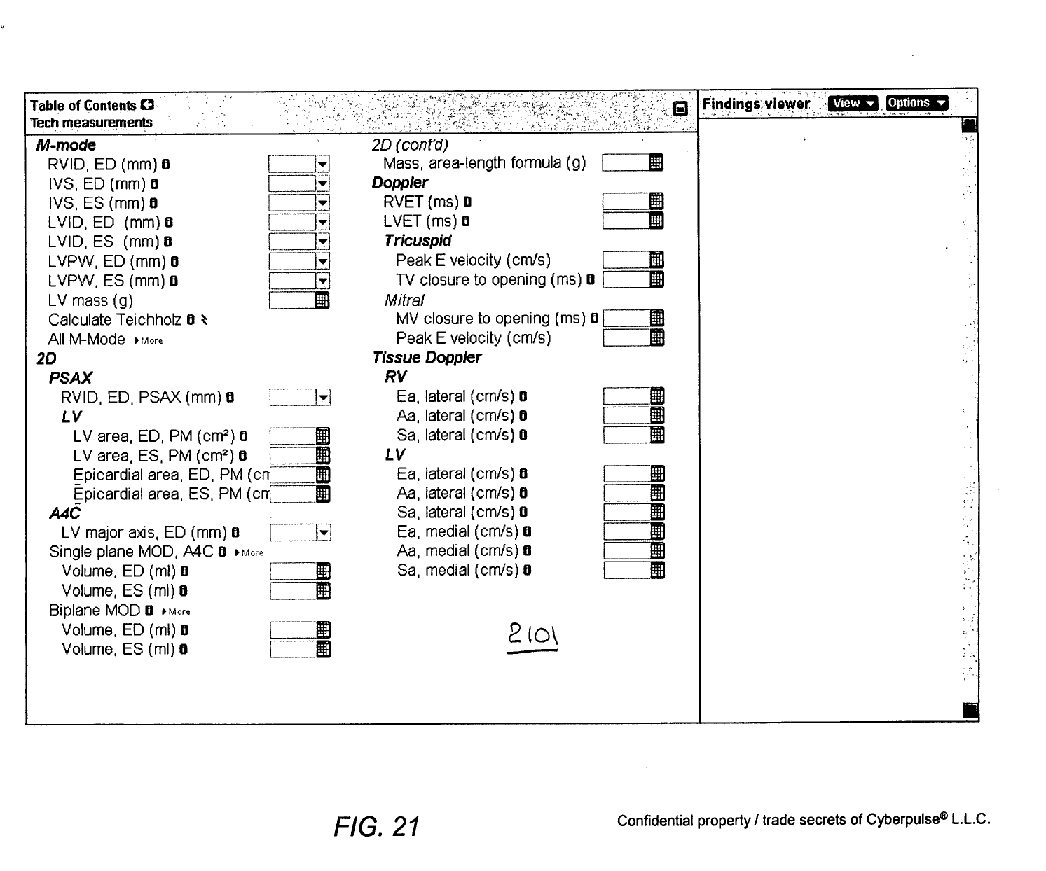

Returning to FIG. 19, selecting the “Tech measurements” 1905 in the navigation frame 303 triggers the generation of a corresponding data-entry form 2101 depicted in FIG. 21 that presents a set of measurement-related data-entry opportunities. As with the “Tetralogy of Fallot” form, this “Tech measurements” data-entry form 2101 draws its contents from throughout the knowledge base. Note that in the “Tech measurements” form 2101 these data-entry opportunities are preferably organized first by measurement type (“M-Mode”, “2D”, “Doppler”, and “Tissue Doppler”) and then by ultrasound view (“PSAX” and “A4C”). This order reflects the expected perspective and workflow of the cardiac sonographic technician who will be entering this data rather than the order used in the knowledge base, which is strictly based on anatomy.

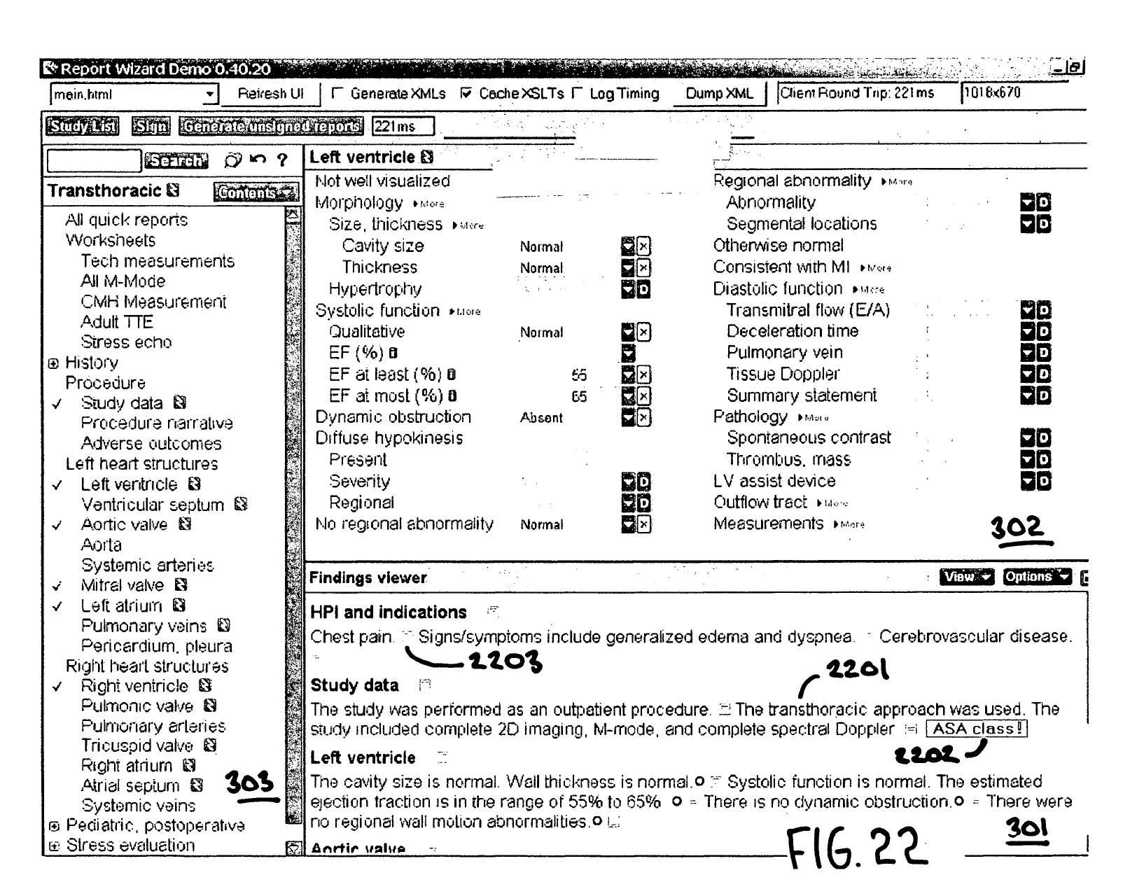

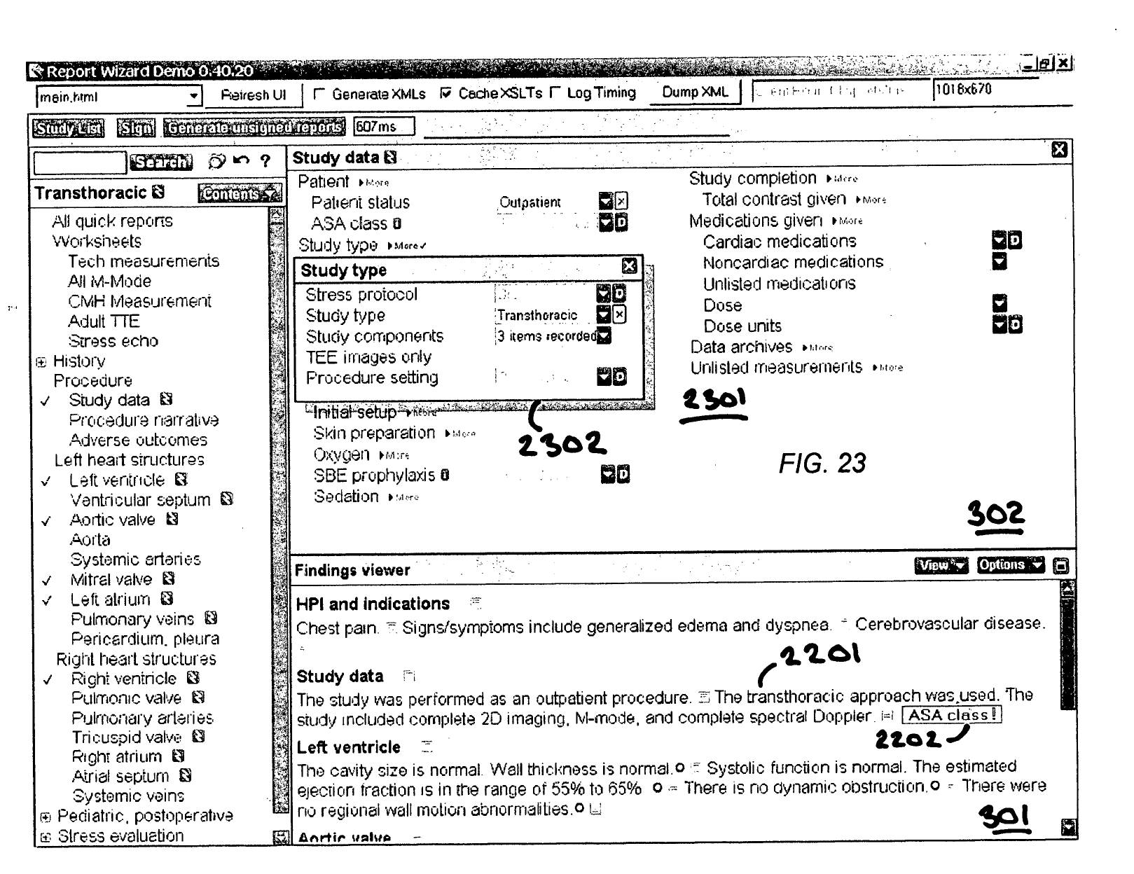

Referring now to FIG. 22, the findings viewer 301 provides a convenient means of reviewing recorded data. The set of recorded findings are presented as narrative report, with individual statements organized by finding group. In a preferred approach, clicking on (or otherwise selecting) a narrative statement in the findings viewer 301 triggers the generation and display of the data-entry form that was used to enter the selected data item, thereby allowing for easy updating or correcting of data. For example, clicking the narrative statement “The transthoracic approach was used. The study included complete 2D imaging, M-mode, and complete spectral Doppler.” 2201 triggers the generation of the form 2301 containing the associated data items as depicted in FIG. 23. In a preferred approach this includes automatically opening the “Study type” secondary form 2302.

In addition to narrative statements, the findings viewer 301 can include markers that denote data that a user is expected to enter. For example, the “ASA class” placeholder marker 2202 depicted in FIG. 22, indicates that the user is expected to enter the patient's American Society of Anesthesiology (ASA) rating as part of the data recorded about that patient. Such a placeholder marker in effect serves, at least in part, to reserve a visible portion of the corresponding report for the associated information it represents. In a preferred approach, clicking on this placeholder marker 2203 triggers the generation and display of a data-entry form 2301 that can be used to enter this data.

It would also be possible, of course, to permit a user to enter free-text statements (using a text-entry mechanism of choice, such as but not limited to a keyboard, voice-recognition, and so forth). Such free-text, when available, could be readily combined and displayed with the automatically generated narrative statements described above. Note markers can be used, if desired, to facilitate this approach and to permit a user to enter a free-text statement at particular positions within the report. For example, and referring again to FIG. 22, in a preferred approach, the user could click a note marker such as the note marker that is denoted by reference numeral 2203 to indicate a desire to enter a free-text statement between the phrases “chest pain” and “signs/symptoms include generalized edema and dyspnea.”

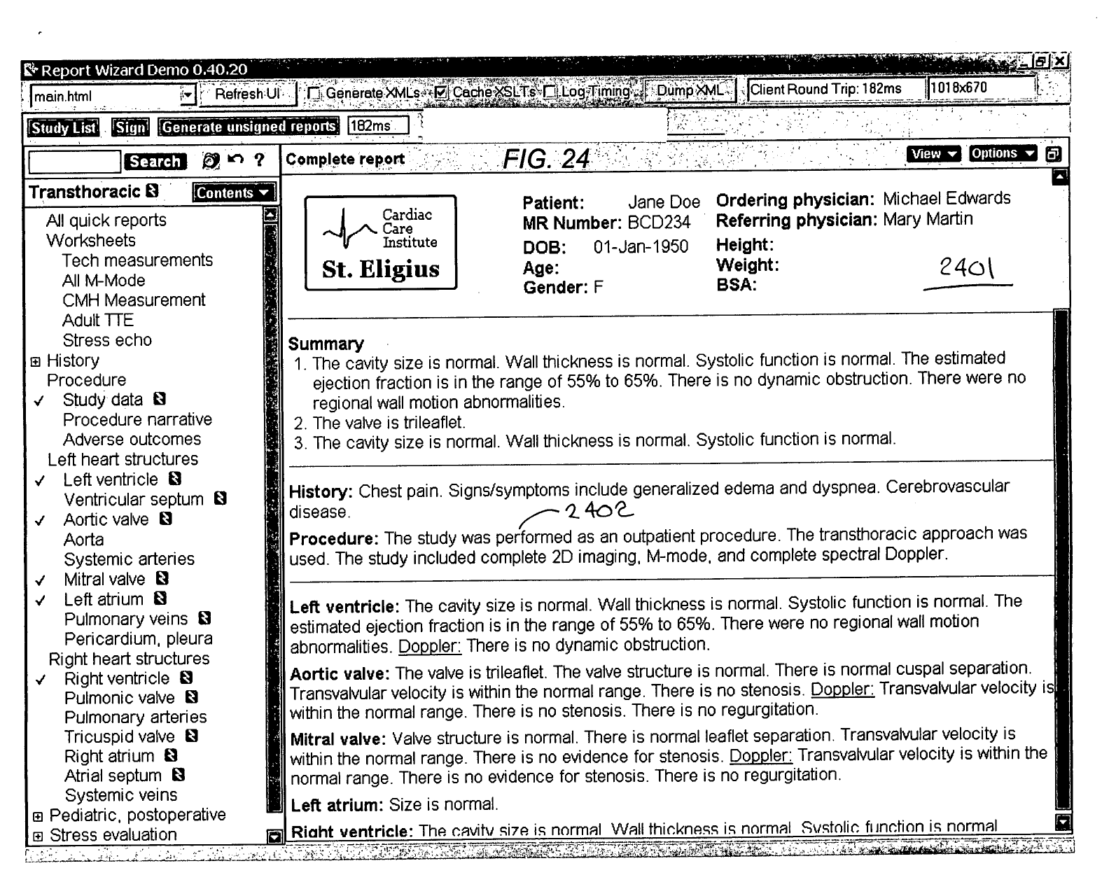

In one preferred but optional embodiment of this invention, the layout of the findings viewer 301 can be set to match the layout of the narrative report 2401 that is transmitted following completion of the data entry process FIG. 24 depicts such a result. This allows a user to review not only the recorded data but precisely how that data will be communicated to others in the narrative report.

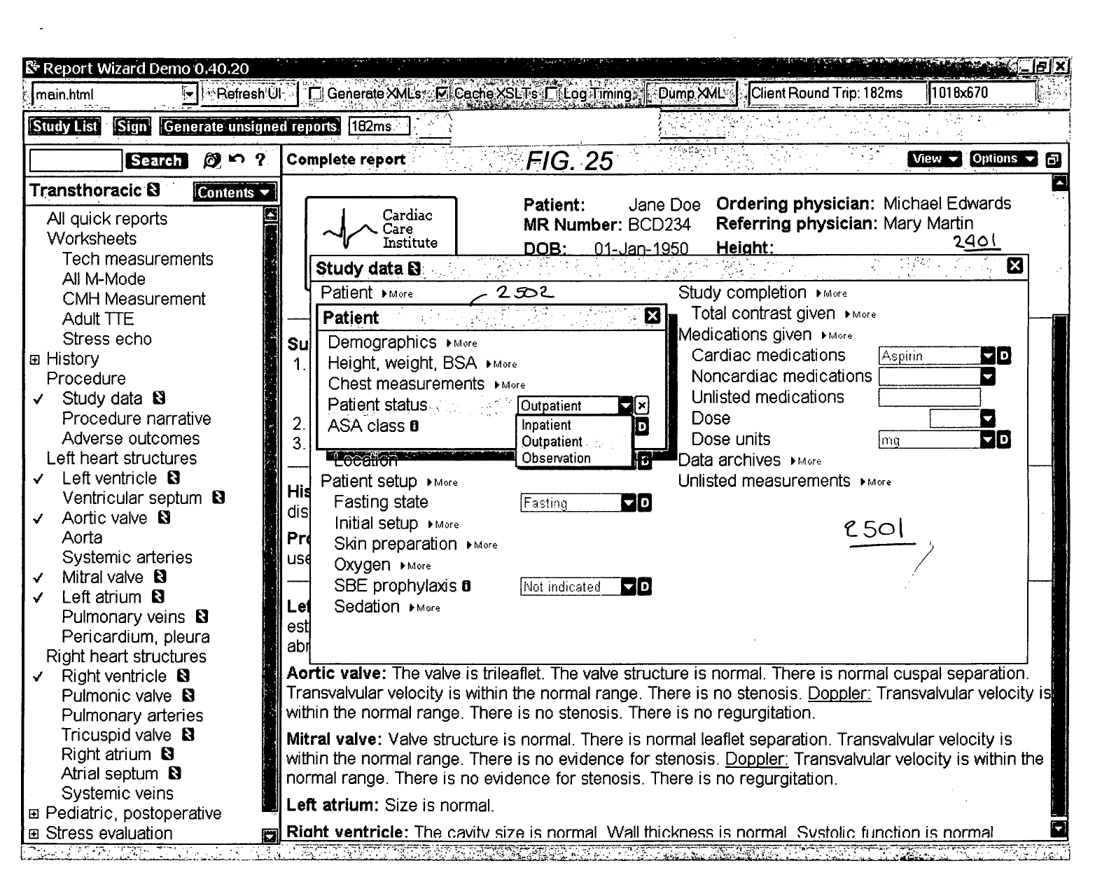

In a preferred approach, clicking on a particular narrative statement triggers the generation and display of the data-entry form that was used to enter the corresponding selected data item. To illustrate, clicking the narrative statement “The study was performed as an outpatient procedure.” 2402 triggers the generation of the corresponding data-entry form 2501 containing the associated data items as depicted in FIG. 25. In a preferred approach the display of a primary “Study data” data-entry form 2501 overlays the narrative report and further includes the automatic display of corresponding nested content such as the depicted “Patient” secondary data-entry form 2502.

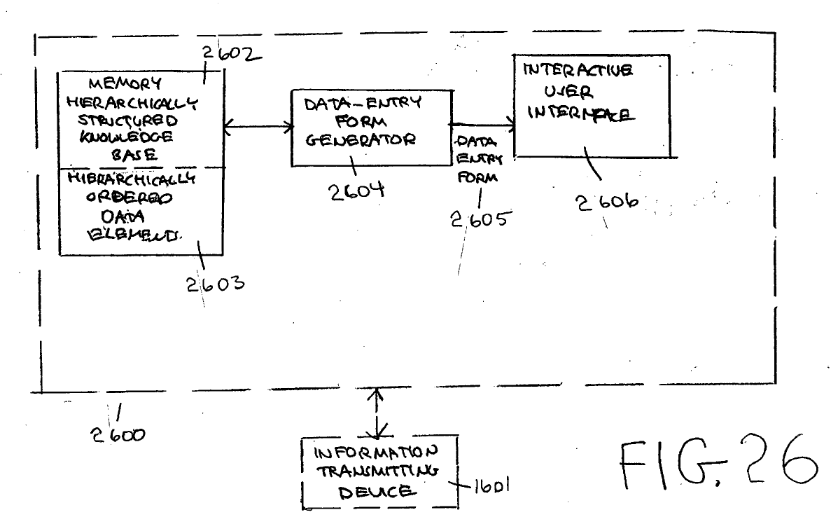

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 26, an illustrative approach to such a platform will now be provided.

An exemplary apparatus 2600 comprises a memory 2602, wherein the memory has a hierarchically structured knowledge base stored therein and wherein the hierarchically structured knowledge base comprises hierarchically ordered data elements 2603 that are preferably configured and arranged as described above. The apparatus 2600 further comprises a data-entry form generator 2604, wherein the data-entry form generator has an input operably coupled to the memory 2602 and an output operably coupled to an interactive user interface 2606. The data-entry form generator 2605 outputs a data-entry form 2605 to the interactive user interface 2606 wherein the data-entry form 2605 comprises a plurality of data-entry columns of data-entry opportunities such as those described above. In an optional but preferred embodiment, the apparatus 2600 can be configured such that the data-entry form generator 2605 is operably coupled to an information transmitting device 2601 to permit corresponding communications with a remotely located interactive user interface, storage point, administrative node, and so forth as may be desired.

Those skilled in the art will recognize and understand that such an apparatus may be comprised of a plurality of physically distinct elements as is suggested by the illustration shown in FIG. 26. It is also possible, however, to view this illustration as comprising a logical view, in which case one or more of these elements can be enabled and realized via a shared platform. It will also be understood that such a shared platform may comprise a wholly or at least partially programmable platform as are known in the art.

By these teachings a user can make data entries as correspond to any of a wide variety of procedures and/or syndrome-based studies in a manner that tends to assure that important information is easily accessible and not inadvertently left unentered. The multi-column format of the data entry forms tends to reveal when there are more columns of data-entry opportunities to be consider than can be conveniently displayed in a simultaneous manner. This results, in part, because of an increased likelihood that at least some data-entry opportunities that are not fully displayable at a given time are, nevertheless, at least partially displayed. This contrasts sharply with single column forms where there may often be no intuitive and obvious indication that there are non-displayed candidate data-entry opportunities to consider.

Those skilled in the art will also recognize and appreciate that the data-entry opportunities as are displayed to facilitate data entry are not necessarily ordered in a manner conforming to the hierarchical order that characterizes the hierarchically structured knowledge base itself. Instead, they can be selected and presented in any other order as may be appropriate to the needs of a given application setting. This aids both in avoiding the need to display data-entry opportunities that are unnecessary to a particular data entry activity and further avoiding what may be an arbitrary ordering of data-entry opportunities that fails to match what might otherwise be a more intuitive or natural flow of data entry candidates.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a hierarchically structured knowledge base comprising hierarchically ordered data elements;
providing an interactive user interface operably coupled to the hierarchically structured knowledge base;
generating a data-entry form that is displayable on the interactive user interface using the hierarchically structured knowledge base, wherein the data-entry form comprises a plurality of data-entry columns of data-entry opportunities.

2. The method of claim 1 wherein the data-entry opportunities are not necessarily ordered in a manner that conforms with a hierarchical order as characterizes the hierarchically structured knowledge base.

3. The method of claim 1 wherein at least one of the data-entry opportunities comprises a multi-entry data-entry opportunity.

4. The method of claim 3 wherein the multi-entry data-entry opportunity comprises a link to a secondary data-entry opportunity.

5. The method of claim 4 wherein the secondary data-entry opportunity comprises a secondary data-entry form.

6. The method of claim 5 wherein the secondary data-entry form at least partially overlies the data-entry form upon selecting the multi-entry data-entry opportunity as corresponds thereto.

7. The method of claim 1 wherein generating the data-entry form comprises dynamically generating the data-entry form in response to detecting, via the interactive user interface, that a user needs to enter data using the interactive user interface.

8. The method of claim 1 wherein generating the data-entry form comprises automatically selecting particular data elements from the hierarchically structured data base to use when generating the data-entry form as a function, at least in part, of determining a kind of data reporting activity to be supported through use of the data-entry form.

9. The method of claim 8 wherein automatically selecting particular data elements from the hierarchically structured data base to use when generating the data-entry form as a function, at least in part, of determining a kind of data reporting activity to be supported through use of the data-entry form further comprises automatically selecting a first set of data elements when the kind of data reporting activity comprises a human medical condition syndrome-based reporting activity.

10. The method of claim 8 wherein automatically selecting particular data elements from the hierarchically structured data base to use when generating the data-entry form as a function, at least in part, of determining a kind of data reporting activity to be supported through use of the data-entry form further comprises automatically selecting a first set of data elements when the kind of data reporting activity comprises a human medical condition disorder-based reporting activity.

11. The method of claim 8 wherein automatically selecting particular data elements from the hierarchically structured data base to use when generating the data-entry form as a function, at least in part, of determining a kind of data reporting activity to be supported through use of the data-entry form further comprises automatically selecting a first set of data elements when the kind of data reporting activity comprises a human anatomy-based reporting activity.

12. The method of claim 8 wherein automatically selecting particular data elements from the hierarchically structured data base to use when generating the data-entry form as a function, at least in part, of determining a kind of data reporting activity to be supported through use of the data-entry form further comprises automatically selecting a first set of data elements when the kind of data reporting activity comprises a human disease state-based reporting activity.

13. The method of claim 8 wherein automatically selecting particular data elements from the hierarchically structured data base to use when generating the data-entry form as a function, at least in part, of determining a kind of data reporting activity to be supported through use of the data-entry form further comprises automatically selecting a first set of data elements when the kind of data reporting activity comprises a medical procedure-based reporting activity.

14. The method of claim 1 wherein generating a data-entry form comprises generating a human medical condition syndrome-based reporting data-entry form.

15. The method of claim 1 wherein generating a data-entry form comprises generating a human medical condition disorder-based reporting data-entry form.

16. The method of claim 1 wherein generating a data-entry form comprises generating a human anatomy-based reporting data-entry form.

17. The method of claim 1 wherein generating a data-entry form comprises generating a human disease state-based reporting data-entry form.

18. The method of claim 1 wherein generating a data-entry form comprises generating a medical procedure-based reporting data-entry form.

19. The method of claim 1 further comprising:
displaying the data-entry form via the interactive user interface to provide a displayed data-entry form.

20. The method of claim 19 further comprising:
receiving user data entries via the displayed data-entry form.

21. The method of claim 20 further comprising:
storing the user data entries in a findings database as part of a corresponding report.

22. The method of claim 21 further comprising:
displaying the user data entries as part of a corresponding report.

23. The method of claim 22 further comprising:
detecting selection of a user data entry from a displayed corresponding report;
in response to detecting selecting of the user data entry form from the displayed corresponding report, displaying a data-entry form that was used to enter the selected user data entry.

24. The method of claim 22 wherein the corresponding report further comprises at least one free-text entry.

25. The method of claim 22 wherein displaying the user data entries as part of a corresponding report further comprises displaying a corresponding report comprising at least one placeholder marker wherein the placeholder marker represents a user data entry that has not yet been user entered.

26. The method of claim 25 further comprising:
detecting user selection of the placeholder marker;
in response to detecting user selection of the placeholder marker, displaying a corresponding user data entry opportunity to facilitate user entry of the user data entry as corresponds to the placeholder marker.

27. The method of claim 21 wherein the corresponding report comprises at least one of:
a human medical condition syndrome-based report;
a human medical condition disorder-based report;
a human anatomy-based report;
a human disease state-based report;
a medical procedure-based report.

28. The method of claim 27 wherein generating a data-entry form comprises receiving input from a user via the interactive user interface and selecting a particular kind of corresponding report based, at least in part, upon the input from the user.

29. The method of claim 19 wherein displaying the data-entry form via the interactive user interface further comprises also displaying at least one navigation opportunity.

30. The method of claim 29 wherein the at least one navigation opportunity provides access to at least one part of the hierarchically structured knowledge base.

31. The method of claim 30 wherein the access to the at least one part of the hierarchically structured knowledge base comprises a non-data-entry point of access.

32. The method of claim 1 further comprising:
displaying, via the interactive user interface, at least a portion of a given data-entry opportunity in conjunction with a non-alphanumeric graphic element.

33. The method of claim 32 wherein the non-alphanumeric graphic element comprises a graphic representation of a data element as corresponds to subject matter of the given data-entry opportunity.

34. The method of claim 1 wherein at least one of the data-entry opportunities comprises a non-alphanumeric graphic element.

35. The method of claim 34 wherein the non-alphanumeric graphic element comprises at least one selectable portion that corresponds to entry of a particular corresponding data element.

36. The method of claim 1 wherein the data-entry opportunities comprise, at least in part, a set of non-alphanumeric graphic elements depicting subject matter as corresponds to the data-entry opportunities and with which a user interacts to enter data.

37. The method of claim 1 further comprising providing an information transmitting device wherein the device communicates with at least one of the data-entry opportunities.

38. An apparatus comprising:
a memory having a hierarchically structured knowledge base comprising hierarchically ordered data elements stored therein;
an interactive user interface;
data-entry form generator having an input operably coupled to the memory and having an output operably coupled to the interactive user interface comprises a data-entry form comprising a plurality of data-entry columns of data-entry opportunities.

39. The apparatus of claim 38 wherein the data-entry form generator comprises means for generating a data-entry form that is displayable on the interactive user interface using the hierarchically structured knowledge base, wherein the data-entry form comprises a plurality of data-entry columns of data-entry opportunities.

40. The apparatus of claim 38 wherein at least one of the data-entry opportunities comprises a multi-entry data-entry opportunity.

41. The apparatus of claim 40 wherein the multi-entry data-entry opportunity comprises a link to a secondary data-entry opportunity.

42. The apparatus of claim 41 wherein the secondary data-entry opportunity comprises a secondary data-entry form.

43. The apparatus of claim 38 wherein the data-entry form generator dynamically generates the data-entry form in response to detecting, via the interactive user interface, that a user needs to enter data using the interactive user interface.

44. The apparatus of claim 38 wherein the data-entry form generator automatically selects particular data elements from the hierarchically structured data base to use when generating the data-entry form as a function, at least in part, of determining a kind of data reporting activity to be supported through use of the data entry form.

45. The apparatus of claim 38 wherein the interactive user interface displays at least a portion of a given data-entry opportunity in conjunction with a non-alphanumeric graphic element.

46. The apparatus of claim 38 wherein at least one of the data-entry opportunities comprises a non-alphanumeric graphic element.

47. The apparatus of claim 38 wherein the data-entry opportunities comprise, at least in part, a set of non-alphanumeric graphic elements depicting subject matter as corresponds to the data-entry opportunities and with which a user interacts to enter data.

48. The apparatus of claim 38 wherein at least one of the data-entry opportunities is populated by a predetermined set of data.

49. The apparatus of claim 38 wherein the data-entry form generator is operably coupled to an information transmitting device separate from the apparatus.
